(19) United States
(12) Patent Application Publication
(10) Pub. No.: US 2019/0141481 A1
(43) Pub. Date: May 9, 2019

(54) MANAGEMENT SYSTEM, MOBILE BODY, MANAGEMENT DEVICE, VELOCITY NOTIFICATION METHOD, MANAGEMENT METHOD, AND STORAGE MEDIUM HAVING PROGRAM STORED THEREON

(71) Applicant: NEC Corporation, Minato-ku, Tokyo (JP)

(72) Inventors: Makoto FUJINAMI, Tokyo (JP); Yasuhiro MIZUKOSHI, Tokyo (JP)

(73) Assignee: NEC Corporation, Minato-ku, Tokyo (JP)

(21) Appl. No.: 16/096,381

(22) PCT Filed: Apr. 14, 2017
(86) PCT No.: PCT/JP2017/015224

§ 371 Date: Oct. 25, 2018

(30) Foreign Application Priority Data
Apr. 28, 2016 (JP) 2016-090061

(51) Int. Cl. H04W 4/029; H04W 4/02

(52) U.S. Cl. CPC H04W 4/029; H04W 4/027

(57) ABSTRACT

A management system, according to one aspect of the present invention, includes: a mobile body that uses a predetermined motion model to estimate, on the basis of the velocity of the own device, the position of an own device after a predetermined period has elapsed; and a management device that uses the predetermined motion model to estimate, on the basis of information about the velocity of the mobile body, the position of the mobile body after the predetermined period has elapsed. The management system is further characterized in that when an error between the position of the own device measured after the predetermined period has elapsed and the estimated position of the own device exceeds a predetermined threshold, the mobile body transmits information about the velocity of the own device to the management device.

### TECHNICAL FIELD

The present invention relates to a management system, a mobile body, a management device, a velocity notification method, a management method, and a program.

### BACKGROUND ART

PTL 1 discloses a system for managing a location of a mobile terminal in a cloud. The system described in PTL 1 identifies a location of a mobile terminal, and successively transmits information on the identified location to a mobile management server on the cloud side via a network. The mobile management server on the cloud side provides a service based on a location of a mobile terminal, on the basis of location information successively transmitted from the mobile terminal.

### CITATION LIST

### Patent Literature

[PTL 1] International Publication No. WO2013/161439

[PTL 2] Japanese Unexamined Patent Application Publication No. 2005-309513

[PTL 3] Japanese Unexamined Patent Application Publication No. 2011-061713

[PTL 4] Japanese Unexamined Patent Application Publication No. 2015-232852

### SUMMARY OF INVENTION

### Technical Problem

In the system described in PTL 1, a mobile terminal successively transmits identified location information to a mobile management server on the cloud side via a network. Therefore, in the system described in PTL 1, communication traffic between a mobile terminal and a mobile management server becomes enormous, and load of a network increases. When Internet of Things (IoT) and machine to machine (M2M) spread, it is expected that the number of mobile terminals increases, and an increase in load of a network becomes conspicuous.

Thus, in view of the above-described problem, the present invention is to provide a mobile body, a management device, a management system, and a program, which enable to suppress an increase in load of a network when a location of the mobile body is managed on a cloud side.

### Solution to Problem

A management system, according to an aspect of the present invention, includes: a mobile body for estimating a location of an own device after a predetermined time elapses by using a predetermined motion model, based on a velocity of the own device; and a management device for estimating a location of the mobile body after the predetermined time elapses, by using the predetermined motion model, based on information relating to a velocity of the mobile body, wherein the mobile body transmits, to the management device, information relating to a velocity of an own device in response to an error exceeding a predetermined threshold value, the error being between a location of an own device measured after a predetermined time elapses, and the estimated location of the own device.

A mobile body, according to an aspect of the present invention, includes: first means for transmitting information relating to a velocity of an own device to a management device; and second means for estimating a location of an own device after a predetermined time elapses, by using a predetermined motion model, based on a velocity of the own device, wherein the second means transmits, to the management device, information relating to a velocity of the own device via the first means in response to an error exceeding a predetermined threshold value, the error being between a location of an own device measured after a predetermined time elapses, and the estimated location of the own device.

A management device, according to an aspect of the present invention which manages a location of a mobile body, includes: first means for receiving information relating to a velocity of the mobile body from the mobile body; and second means for estimating a location of the mobile body after a predetermined time elapses, by using a predetermined motion model, based on information relating to a velocity of the mobile body, wherein the second means manages the estimated location as a location of the mobile body for a period until information relating to a velocity of the mobile body is newly received, after receiving information relating to a velocity of the mobile body.

A velocity notification method, according to an aspect of the present invention, includes: transmitting information relating to a velocity of an own device to a management device; estimating a location of an own device after a predetermined time elapses, by using a predetermined motion model, based on a velocity of the own device; and transmitting, to the management device, information relating to a velocity of the own device via first means in response to an error exceeding a predetermined threshold value, the error being between a location of an own device measured after a predetermined time elapses, and the estimated location of the own device.

A management method, according to an aspect of the present invention, includes: receiving information relating to a velocity of a mobile body from the mobile body; estimating a location of the mobile body after a predetermined time elapses, by using a predetermined motion model, based on information relating to a velocity of the mobile body; and managing the estimated location as a location of the mobile body for a period until information relating to a velocity of the mobile body is newly received, after receiving information relating to a velocity of the mobile body.

A program, according to an aspect of the present invention, causes a computer to execute: a step of receiving information relating to a velocity of a mobile body from the mobile body; a step of estimating a location of the mobile body after a predetermined time elapses, by using a predetermined motion model, based on information relating to a velocity of the mobile body; and a step of managing the estimated location as a location of the mobile body for a period until information relating to a velocity of the mobile body is newly received, after receiving information relating to a velocity of the mobile body.

### Advantageous Effects of Invention

A management system, a mobile body, a management device, a management method, and a program according to the present invention enable to suppress an increase in load of a network when a location of the mobile body is managed on a cloud side.

### BRIEF DESCRIPTION OF DRAWINGS

FIG. 1 is a configuration example of a management system according to a first example embodiment.

FIG. 2 is a configuration example of a mobile body 1 according to the first example embodiment.

FIG. 3 is an example of a motion estimation circle of the mobile body 1 according to the first example embodiment.

FIG. 4 is another example of the motion estimation circle of the mobile body 1 according to the first example embodiment.

FIG. 5 is another example of the motion estimation circle of the mobile body 1 according to the first example embodiment.

FIG. 6 is another example of the motion estimation circle of the mobile body 1 according to the first example embodiment.

FIG. 7 is a configuration example of a management device 2 according to the first example embodiment.

FIG. 8 is a flowchart illustrating an operation example of the mobile body 1 according to the first example embodiment.

FIG. 9 is a flowchart illustrating another operation example of the mobile body 1 according to the first example embodiment.

FIG. 10 is a flowchart illustrating an operation example of the management device 2 according to the first example embodiment.

FIG. 11 is a flowchart illustrating another operation example of the management device 2 according to the first example embodiment.

FIG. 12 is a configuration example of a management system according to a second example embodiment.

FIG. 13 is a configuration example of a mobile body 1 according to the second example embodiment.

FIG. 14 is an example of a motion estimation circle of the mobile body 1 according to the second example embodiment.

FIG. 15 is another example of the motion estimation circle of the mobile body 1 according to the second example embodiment.

FIG. 16 is a display example of a display unit of the mobile body 1 according to the second example embodiment.

FIG. 17 is a flowchart illustrating an operation example of the mobile body 1 according to the second example embodiment.

FIG. 18 is a flowchart illustrating an operation example of the management device 2 according to the second example embodiment.

FIG. 19 is a table illustrating a correspondence relationship between a “velocity” and a “code” in a third example embodiment.

FIG. 20 is a table illustrating a correspondence relationship between a “range of velocity” and a “code” in the third example embodiment.

FIG. 21 is a flowchart illustrating an operation example of a mobile body 1 according to the third example embodiment.

FIG. 22 is a flowchart illustrating an operation example of a management device 2 according to the third example embodiment.

FIG. 23 is a table illustrating a correspondence relationship between a “velocity” and a “code” in a fourth example embodiment.

FIG. 24 is a configuration example of a management system according to the fourth example embodiment.

FIG. 25 is an example of a motion estimation circle and an actual locus of a mobile body 1 in a fifth example embodiment.

FIG. 26 is an example illustrating a locus of the mobile body 1 in the fifth example embodiment.

FIG. 27 is a configuration example of a management system according to the fifth example embodiment.

### EXAMPLE EMBODIMENT

In the following, example embodiments and examples according to the present invention will be described with reference to the drawings. Each example embodiment is an example. The present invention is not limited to each example embodiment. Note that reference numbers in the drawings appended to this summary are provided to each element for convenience, as an example for aiding understanding. Description of this summary does not intend any limitation.

### First Example Embodiment

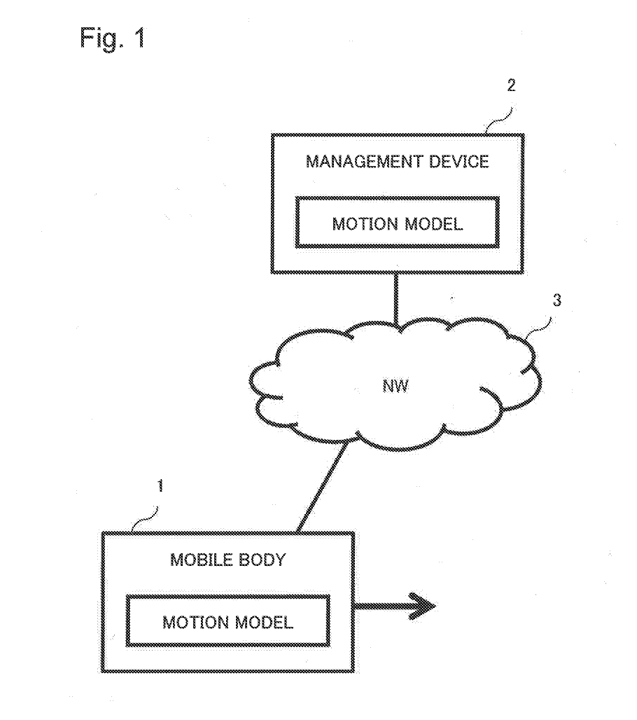

FIG. 1 is a diagram illustrating a configuration example of a management system according to a first example embodiment of the present invention.

In the first example embodiment, each of a mobile body 1 and a management device 2 holds a motion model, and the motion models are associated with each other. The mobile body 1 and the management device 2 estimate a location of the mobile body 1 after a predetermined time has elapsed. The associated motion models are same motion models, for example. Since each of the mobile body 1 and the management device 2 estimates a location of the mobile body 1 by using the associated motion model estimated locations of the mobile body 1 to be estimated by the mobile body 1 and the management device 2 exhibit substantially same results.

Therefore, when an error on a location of the mobile body 1 after a predetermined time has elapsed is small compared with an estimated location, the management device 2 manages the estimated location as a location of the mobile body 1. Since an error between an actual location and an estimated location is small, the management device 2 is able to manage the estimated location as a location of the mobile body 1. Further, since the management device 2 manages an estimated location as a location of the mobile body 1, the management device 2 does not have to receive a notification on location information on the mobile body 1 from the mobile body 1. Therefore, the mobile body 1 does not have to notify the management device 2 of location information on the mobile body 1. This enables to suppress an increase in communication traffic.

Specifically, when an error between an actual location of the mobile body 1, and an estimated location estimated by using a motion model exceeds a predetermined threshold value, the mobile body 1 notifies the management device 2 of information relating to a location of the mobile body 1. On the other hand, when an error between an actual location of the mobile body 1, and an estimated location estimated by using a motion model falls within a predetermined threshold value range, the mobile body 1 does not notify the management device 2.

After receiving information relating to a location of the mobile body 1 from the mobile body 1, the management device 2 manages an estimated location estimated by using a motion model as a location of the mobile body 1 for a period until newly receiving information relating to a location of the mobile body 1.

Therefore, the management system according to the first example embodiment does not have to transmit and receive information relating to a location of the mobile body 1 between the mobile body 1 and the management device 2, when an error between an actual location of the mobile body 1, and an estimated location of the mobile body 1 estimated by using a motion model falls within a predetermined threshold value range. Thus, the management system according to the first example embodiment is able to suppress an increase in communication traffic.

As illustrated in FIG. 1, the management system according to the first example embodiment includes the mobile body 1, the management device 2, and a network (NW) 3.

The NW 3 is a long term evolution (LTE), for example. The NW 3, however, is not limited to an LTE, but may be any network such as a general packet radio service (GPRS), a universal mobile telecommunication system (UMTS), and a worldwide interoperability for microwave access (WiMAX).

The mobile body 1 is a device (object) whose location changes, such as an automobile, a two-wheeled vehicle (motorcycle), a bicycle, a drone, a flying object, an airplane, a vessel, and a train, for example. The mobile body 1 may be a bicycle (electric bicycle) loaded with a battery. The mobile body 1 may be a flying object for carrying things, for example. The mobile body 1 may be a mobile body to be operated by a remote controller and the like, for example. Further, the mobile body 1 may be a device carried by a user, such as a mobile phone, a personal computer (PC), a mobile router, and a smart device (e.g., a wearable terminal), for example, and may be a device that moves with the user. Note that the mobile body 1 is not limited to these examples, but may be a machine to machine (M2M) device, and the like. Note that the mobile body 1 may be a communication device (e.g., a mobile phone, a smartphone, a car navigation system, and the like) included in a moving object such as an automobile, a train, and an airplane.

The mobile body 1 transmits information relating to a location of an own device to the management device 2. The mobile body 1 transmits information relating to a location of an own device to the management device 2 at a predetermined timing, for example. The mobile body 1 transmits, to the management device 2, location information on an own device measured by a global positioning system (GPS) (e.g., a latitude and a longitude of the mobile body 1), for example. The mobile body 1 may transmit location-related information of an own device (e.g., an acceleration and a velocity of the mobile body 1). Further, the mobile body 1 may transmit, to the management device 2, a motion model for use in calculating a location of an own device.

The management device 2 manages information relating to a location of the mobile body 1. The management device 2 manages a location of the mobile body 1, based on information relating to a location of the mobile body 1 received from the mobile body 1 (location information and/or location-related information). The management device 2 manages location information received from the mobile body 1 (e.g., a latitude and a longitude of the mobile body 1), for example. The management device 2 may calculate a location of the mobile body 1, based on received location-related information (e.g., a velocity and an acceleration of the mobile body 1), and manage the calculated location of the mobile body 1, for example. Note that, when receiving a motion model for use in calculating a location of the mobile body 1, the management device 2 may calculate a location of the mobile body 1 by using the received motion model, and manage the calculated location of the mobile body 1.

The management device 2 estimates a location of the mobile body 1 after a predetermined time has elapsed, based on a predetermined motion model. The management device 2 estimates a location of the mobile body 1 after a predetermined time has elapsed by using a predetermined motion model, based on information relating to the received location of the mobile body 1, for example. Note that the management device 2 may calculate a location of the mobile body 1, based on information relating to a location received from the mobile body 1, and thereafter, estimate a location of the mobile body 1 after a predetermined time has elapsed by using a predetermined motion model, based on the calculated location of the mobile body 1. When receiving a motion model from the mobile body 1, the management device 2 may estimate a location of the mobile body 1 after a predetermined time has elapsed by using the motion model.

The management device 2 manages an estimated location of the mobile body 1 after a predetermined time has elapsed. After receiving information relating to a location from the mobile body 1, the management device 2 manages an estimated location of the mobile body 1 as a location of the mobile body 1 for a period until newly receiving information relating to a location from the mobile body 1.

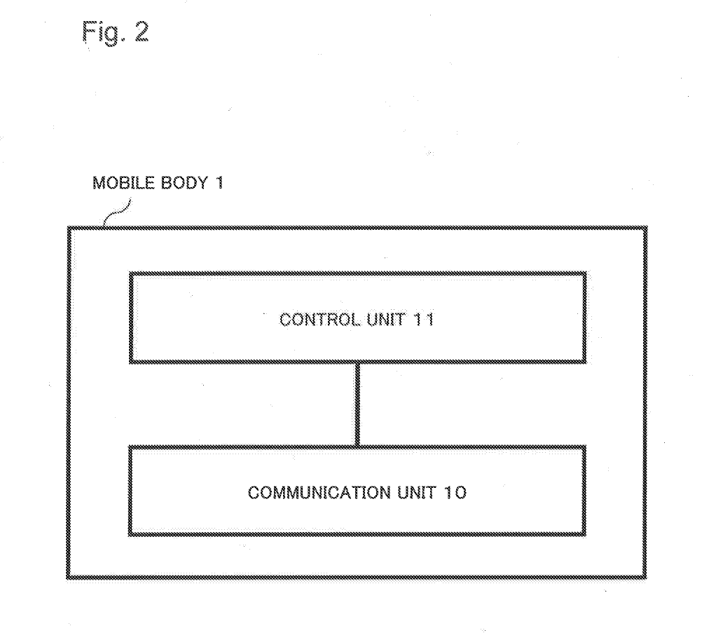

FIG. 2 is a diagram illustrating a configuration example of the mobile body 1 according to the first example embodiment. As exemplified in FIG. 2, the mobile body 1 includes a communication unit 10 and a control unit 11.

The communication unit 10 has a function of transmitting and receiving a predetermined signal, data, and the like. The communication unit 10 is an interface for communication, for example.

The control unit 11 measures information relating to a location of an own device. The control unit 11 measures information relating to a location of an own device at a predetermined period, for example. The control unit 11 measures information relating to a location of an own device at a predetermined timing, for example. Information relating to a location of the mobile body 1 is location information on the mobile body 1 and/or location-related information of the mobile body 1, for example. Note that information relating to a location of the mobile body 1 is not limited to location information, but may include a motion model for use in calculating a location of the mobile body 1, for example.

The control unit 11 measures location information on an own device (e.g., a latitude and a longitude) by a GPS, for example. Location information may include an altitude of an own device, an elevation where the mobile body 1 is located, and the like, in addition to a latitude and a longitude. Note that location information is not limited to these examples, but may be any information as long as the information indicates a location of the mobile body 1. Note that location information is settable depending on an attribute of the mobile body 1. For example, when the mobile body 1 is an automobile, location information includes a latitude and a longitude. Further, when the mobile body 1 is a drone or an airplane, location information includes a latitude, a longitude, and an altitude.

Further, the control unit 11 measures location-related information of an own device (e.g., a velocity and an acceleration of the own device), for example. Location-related information may be angular moment with respect to respective axes (X-axis, Y-axis, Z-axis), a “speed” being a scalar quantity, and the like, in addition to a velocity and an acceleration.

Location-related information may be a parameter included in a motion model for use in calculating a location of the mobile body 1.

Location-related information may be a motion model for use in calculating a location of the mobile body 1. A motion model includes an equation of motion for calculating a location of the mobile body 1, for example.

Location-related information may be information indicating a location of the mobile body 1 on a predetermined map, for example.

Location-related information may be information for calculating a location of the mobile body 1 on a predetermined map, such as a vector quantity of the mobile body 1 in a traveling direction on a predetermined map, for example.

Note that location-related information is not limited to these examples. When location-related information is information for calculating a location of the mobile body 1, any information may be employed. Note that a location of the mobile body 1 may be a location relative to another mobile body 1, for example.

The control unit 11 estimates a location of the mobile body 1 after a predetermined time has elapsed, based on a predetermined motion model. Note that a “predetermined motion model” included in the mobile body 1 is a model associated with a “predetermined motion model” included in the management device 2. A “predetermined motion model” included in the mobile body 1, and a “predetermined motion model” included in the management device 2 may be the same.

An estimated location of the mobile body 1 to be estimated by the control unit 11 may be a “predetermined area” having a possibility that the mobile body 1 may move after a predetermined time has elapsed, for example. The control unit 11 estimates a location of the mobile body 1 after a predetermined time has elapsed as a motion estimation circle by using a Kalman filter, for example. Note that it is needless to say that the control unit 11 may calculate an estimated location of the mobile body 1 by a method other than a Kalman filter. Further, the control unit 11 may estimate an estimated location of the mobile body 1 not as a motion estimation area but as a “point”.

Further, when estimating a motion estimation area regarding an estimated location of the mobile body 1, the control unit 11 may estimate a “point” at which the mobile body 1 may move with a highest possibility in the motion estimation area.

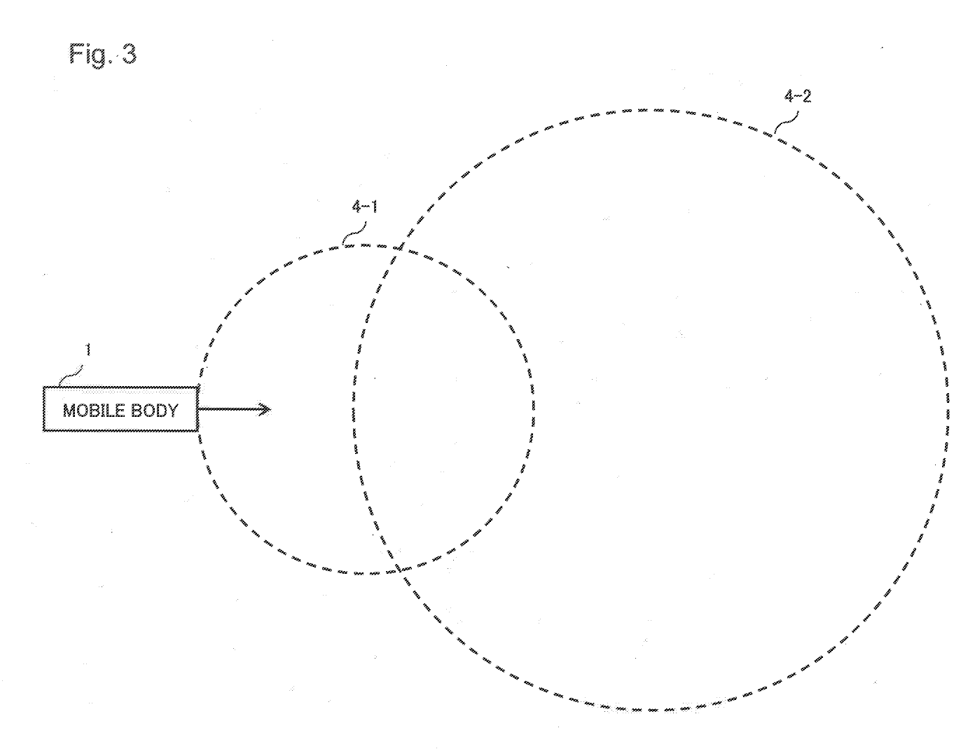

FIG. 3 is a diagram exemplifying a motion estimation circle to be estimated by the control unit 11. The control unit 11 calculates a motion estimation circle 4-1, as an estimated location of the mobile body 1 after a predetermined time “t” has elapsed by using a Kalman filter, for example. The control unit 11 calculates a motion estimation circle 4-2, as an estimated location of the mobile body 1 after a predetermined time “2t” has elapsed by using a Kalman filter. Note that the example of FIG. 3 illustrates a motion estimation circle until a time when a predetermined time “2t” has elapsed. It is needless to say, however, that the control unit 11 may calculate a motion estimation circle after a time when a predetermined time “2t” has elapsed.

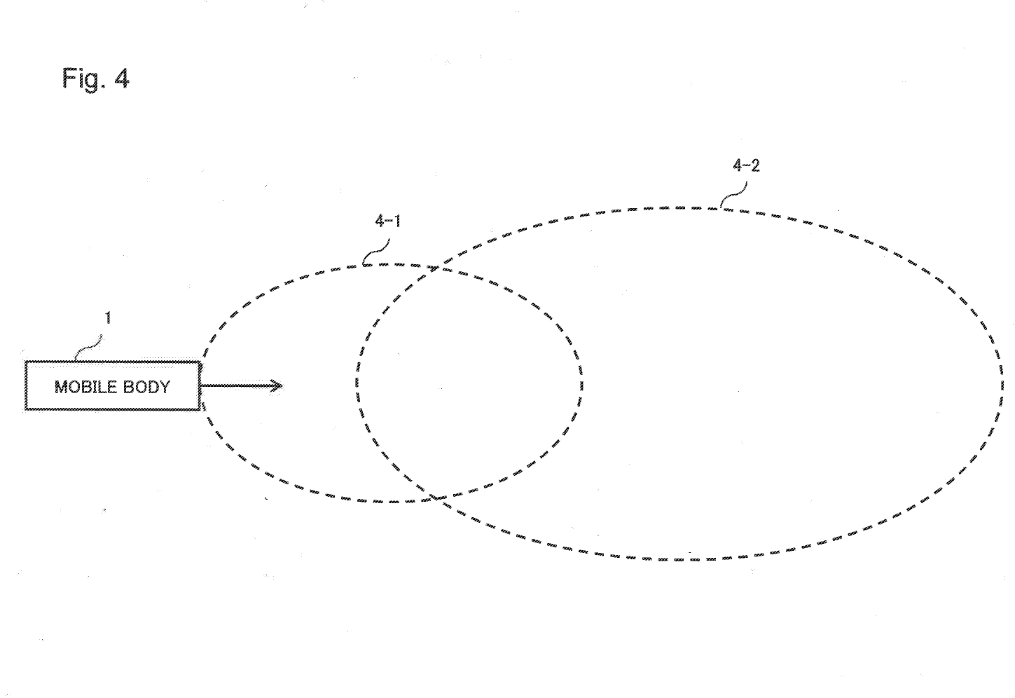

FIG. 4 is a diagram exemplifying a motion estimation area to be estimated by the control unit 11. The control unit 11 may estimate an estimated location of the mobile body 1 as a motion estimation circle as illustrated in FIG. 3. Alternatively, as illustrated in FIG. 4, the control unit 11 may estimate an estimated location of the mobile body 1 as an estimation area of an elliptical shape, for example. In the example of FIG. 4, the control unit 11 estimates a motion estimation area of the mobile body 1 wider (longer) in a traveling direction than a direction orthogonal to the traveling direction. Therefore, in the example of FIG. 4, by calculating a motion estimation area of the mobile body 1 wide (long) in a traveling direction, the motion estimation area of the mobile body 1 has an elliptical shape.

A size of a motion estimation area of the mobile body 1 to be estimated by the control unit 11 may be set depending on an attribute and a type of the mobile body 1. The control unit 11 sets a motion estimation area large with respect to a mobile body 1 that moves at a fast velocity such as an automobile, for example. On the other hand, the control unit 11 sets a motion estimation area small with respect to a mobile body 1 that moves at a slow velocity such as a smartphone carried by a pedestrian, for example.

Further, a size of a motion estimation area of the mobile body 1 to be estimated by the control unit 11 may be set depending on a condition of a place where the mobile body 1 is located. When the mobile body 1 being an automobile is located on a highway, for example, the control unit 11 sets a motion estimation area large. On the other hand, when the mobile body 1 being an automobile is located near an intersection, for example, the control unit 11 sets a motion estimation area small.

Note that an area on an estimated location of the mobile body 1 to be estimated by the control unit 11 is not limited to the examples of FIG. 3 and FIG. 4, but may be any area. Further, in FIG. 3 and FIG. 4, the control unit 11 estimates a motion estimation area of the mobile body 1, as a two-dimensional area. The control unit 11 may estimate a motion estimation area of the mobile body 1 as a one-dimensional area or a three-dimensional area, for example. Further, in FIG. 3 and FIG. 4, the control unit 11 sets a size of a motion estimation area after a predetermined time “2t” has elapsed large between a motion estimation area after a predetermined time “t” has elapsed, and the motion estimation area after the predetermined time “2t” has elapsed. Alternatively, a size of a motion estimation area may be any size. For example, the control unit 11 may estimate a motion estimation area after a predetermined time “t” has elapsed and a motion estimation area after a predetermined time “2t” has elapsed as motion estimation areas of substantially the same sizes. It is needless to say that a size of a motion estimation area after a predetermined time “2t” has elapsed may be smaller than a size of a motion estimation area after a predetermined time “t” has elapsed.

Further, an area on an estimated location of the mobile body 1 to be estimated by the control unit 11 may be set, based on weather information such as a date and time, a point of time, a time zone, and a weather, and based on a car type when the mobile body 1 is an automobile. For example, an area on an estimated location of the mobile body 1 is set to be narrow with respect to a date and time, a point of time, a time zone, a weather, and a car type in which a frequency of occurrence of an accident is statistically higher than a reference value, as compared with a date and time, etc., when the frequency is lower than the reference value, for example.

Further, in the examples of FIG. 3 and FIG. 4, the control unit 11 estimates a motion estimation area of the mobile body 1 each time after a predetermined time “t” has elapsed. Alternatively, the control unit 11 may not estimate a motion estimation area each time after a predetermined time “t” has elapsed, but may estimate a motion estimation area on a real-time basis.

Further, the predetermined time “t” is set, based on an attribute of the mobile body 1, for example. When the mobile body 1 is, for example, an automobile, a train, a drone, and the like, the predetermined time “t” is set to 10 [ms], for example. When the mobile body 1 is, for example, a smartphone, a mobile phone, and the like carried by a user, the predetermined time “t” is set to 1 [s], for example. Note that the predetermined time “t” is not limited to these examples, but may be any time width such as 1 [ms].

Note that the predetermined time “t” may be a time that is determined in advance, or may be changeable depending on a condition of the mobile body 1. For example, when the mobile body 1 is an automobile, for example, the predetermined time “t” may be set shorter in a case where an automobile being the mobile body 1 is located at an intersection than in a case where the automobile is located on a highway. It is needless to say that the predetermined time “t” may be set shorter in a case where an automobile being the mobile body 1 is located on a highway than in a case where the automobile is located at an intersection.

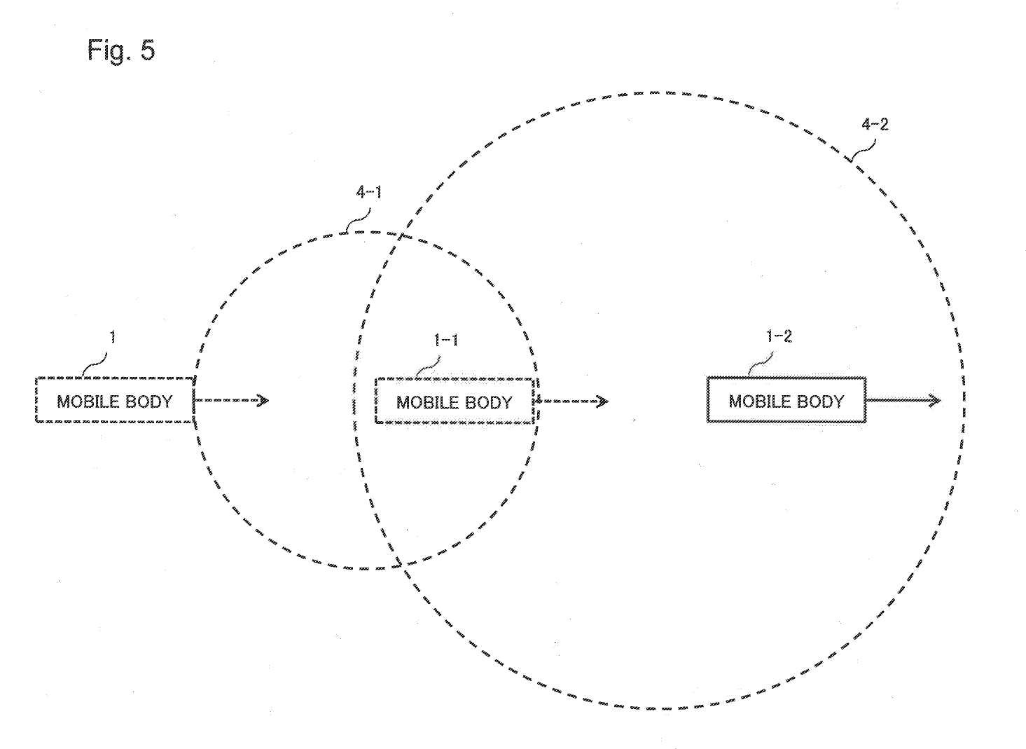

FIG. 5 is a diagram illustrating a relationship between an actual location of the mobile body 1 and a motion estimation circle after the predetermined time “2t” has elapsed.

Further, the predetermined time “t” may be set, based on weather information such as a date and time, a point of time, a time zone, and a weather, and based on a car type when the mobile body 1 is an automobile. For example, the predetermined time “t” is set short with respect to a date and time, a point of time, a time zone, a weather, and a car type in which a frequency of occurrence of an accident is statistically higher than a reference value, as compared with a date and time, etc., when the frequency is lower than the reference value, for example.

As illustrated in FIG. 5, the mobile body 1 is located within the motion estimation circle 4-2 after a predetermined time “2t” has elapsed. In this case, since an actual location of the mobile body 1 after a predetermined time has elapsed falls within a motion estimation circle, the mobile body 1 does not notify the management device 2 of information relating to a location of the mobile body 1. In this case, similarly to the side of the mobile body 1, on the side of the management device 2, a motion estimation circle of the mobile body 1 after the predetermined time has elapsed is estimated. Therefore, the management device 2 manages an estimated area on the motion estimation circle as a location of the mobile body 1. Note that the management device 2 may manage a location where the mobile body 1 may be located with a high possibility within an estimated area on a motion estimation circle as a location of the mobile body 1. For example, the management device 2 may calculate a location where the mobile body 1 may be located with a highest possibility within a motion estimation circle, and manage the calculated location as a location of the mobile body 1.

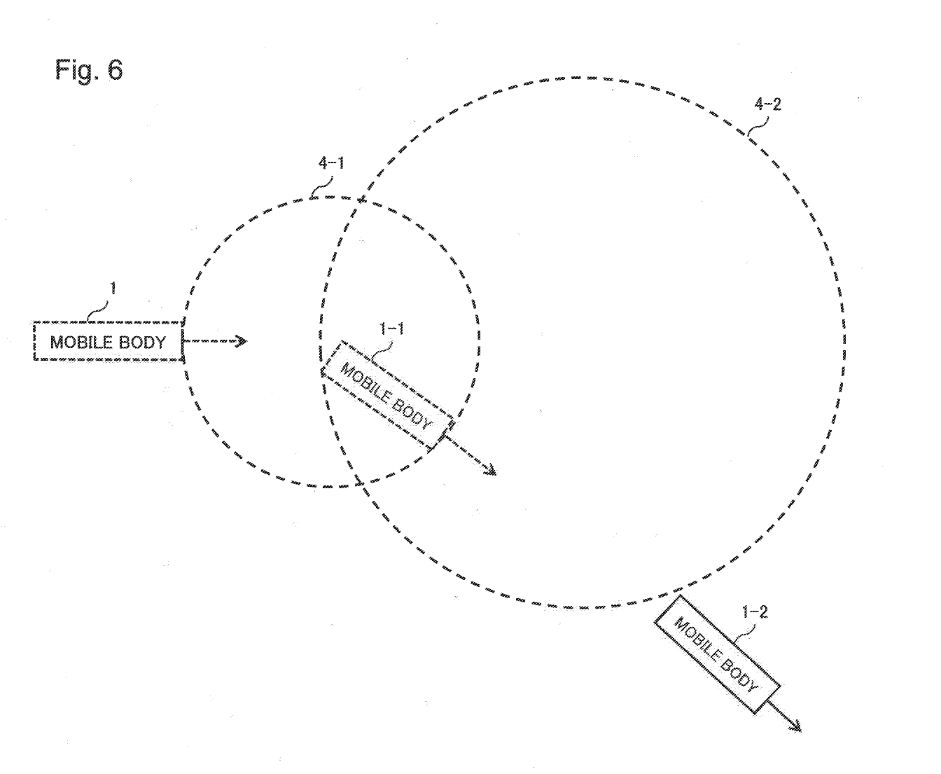

FIG. 6 is a diagram illustrating another relationship between a location of the mobile body 1 and a motion estimation circle after a predetermined time “2t” has elapsed.

As illustrated in FIG. 6, the mobile body 1 is located outside the motion estimation circle 4-2 after a predetermined time “2t” has elapsed. Specifically, this corresponds to a case where an error between an actual location of the mobile body 1 after a predetermined time “2t” has elapsed, and an estimated location exceeds a predetermined threshold value. In this case, the mobile body 1 notifies the management device 2 of information relating to a location of the mobile body 1 in response to an actual location of the mobile body 1 after a predetermined time has elapsed falling outside a motion estimation circle. When receiving information relating to a location from the mobile body 1, the management device 2 calculates a location of the mobile body 1, based on the received information relating to a location, and manages the calculated location of the mobile body 1 as a location of the mobile body 1.

The control unit 11 transmits information relating to a location of the mobile body 1 to the management device 2 via the communication unit 10. The control unit 11 transmits, to the management device 2, location information on an own device measured by a GPS (e.g., a latitude and a longitude), for example. The control unit 11 notifies measured location-related information of an own device (e.g., a velocity and an acceleration of the own device), for example. The control unit 11 may notify the management device 2 of angular moment with respect to respective axes (X-axis, Y-axis, Z-axis), a “speed” being a scalar quantity, and the like as location-related information, in addition to a velocity and an acceleration of the mobile body 1, for example. The control unit 11 may notify the management device 2 of a motion model itself for use in calculating a location of the mobile body 1 as location-related information, for example. The control unit 11 may notify the management device 2 of a parameter of a motion model for use in calculating a location of the mobile body 1 as location-related information, for example. The control unit 11 may notify the management device 2 of a location of the mobile body 1 on a predetermined map as location-related information, for example.

When information relating to a location of the mobile body 1 is transmitted to the management device 2, the control unit 11 may transmit information relating to a location of the mobile body 1 after a predetermined time has elapsed, in place of a current location of the mobile body 1. The mobile body 1 estimates information relating to a location of the mobile body 1 after a predetermined time has elapsed, and transmits the estimated information to the management device 2. The control unit 11 assumes that a predetermined elapsed time as a time required for information transmitted from the mobile body 1 to reach the management device 2. For example, when information transmitted from the mobile body 1 reaches the management device 2 after 0.2 [ms], the mobile body 1 estimates information relating to a location of the mobile body 1 after 0.2 [ms], and notifies the estimated information to the management device 2.

“Information relating to a location of the mobile body 1” notified from the mobile body 1 is information in the past by a time required for communication, when being received by the management device 2. Therefore, the management device 2 cannot use information received from the mobile body 1 as it is. In view of this, as described above, the mobile body 1 estimates information relating to a location of the mobile body 1 at a point of time in the future by a time required for communication, and transmits the estimated information. Thus, the management device 2 is able to use information received from the mobile body 1, as information at a current point of time as it is.

Note that, in the above-described example, the mobile body 1 estimates information relating to the mobile body 1 after a predetermined time has elapsed. Alternatively, the management device 2 that receives the information from the mobile body 1 may estimate information relating to a current location of the mobile body 1 from the received information.

When the mobile body 1 is an automobile, the control unit 11 may notify the management device 2 of information on a brake, an accelerator, and the like of the automobile, as location-related information, for example.

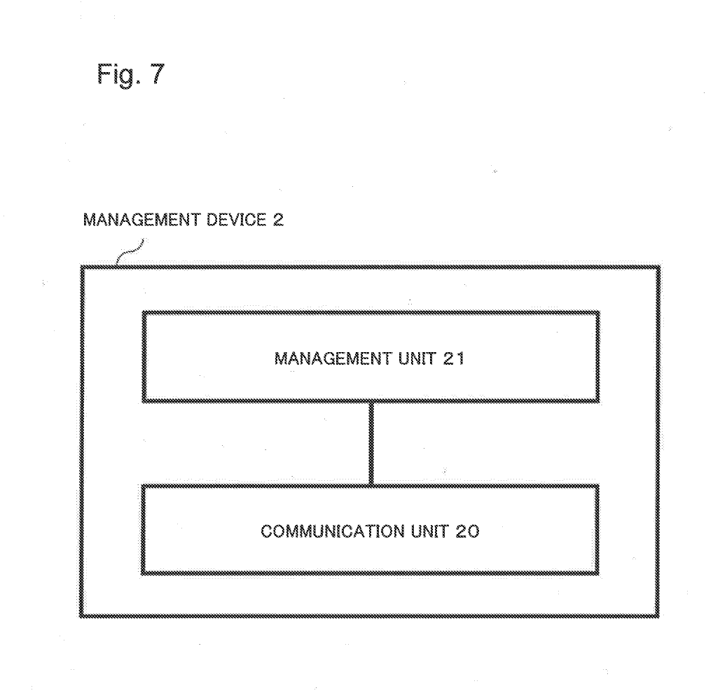

FIG. 7 is a diagram illustrating a configuration example of the management device 2 according to the first example embodiment. As illustrated in FIG. 7, the management device 2 includes a communication unit 20 and a management unit 21.

The communication unit 20 includes a function of transmitting and receiving a predetermined signal, data, and the like. The communication unit 20 is an interface for communication, for example. The management unit 21 manages location information on the mobile body 1.

Location information to be managed by the management unit 21 is a latitude, a longitude, and an altitude of the mobile body 1, for example. Further, location information to be managed by the management unit 21 may be a location of the mobile body 1 on a predetermined map. Note that the management unit 21 may manage location-related information of the mobile body 1, in place of managing location information on the mobile body 1, and calculate location information on the mobile body 1 as necessary. It is needless to say that the management unit 21 may manage both of location information and location-related information of the mobile body 1.

The management unit 21 estimates a location of the mobile body 1 after a predetermined time has elapsed by using a motion model. A motion model for use in estimating a location of the mobile body 1 by the management unit 21 is associated with a motion model to be used by the mobile body 1, and the motion models may be the same, for example. Note that since the management unit 21 uses a motion model associated with a motion model to be used by the mobile body 1, an estimated location to be estimated by the control unit 11 of the mobile body 1, and an estimated location to be estimated by the management unit 21 become substantially same (or same) results.

Note that a predetermined time “t” and a size of a motion estimation circle for use in estimating a location of the mobile body 1 by the management unit 21 are associated with a predetermined time “t” and a size of a motion estimation circle for use in estimating a location of the mobile body 1 by the control unit 11 of the mobile body 1, and have a substantially same value (or same value) and a substantially same size (or same size), for example. In other words, a value of a predetermined time “t” and a size of a motion estimation area to be used by the control unit 11 are set to correspond to or be equal to a value of a predetermined time “t” and a size of a motion estimation area to be used by the management unit 21 so that estimation on a location by the control unit 11 of the mobile body 1 and estimation on a location by the management unit 21 of the management device 2 become substantially same results.

Note that since processing of estimating a location of the mobile body 1 by the management unit 21 is similar to processing of estimating a location of the mobile body 1 by the control unit 11 of the mobile body 1, detailed description is omitted.

When receiving information relating to a location of the mobile body 1 from the mobile body 1, the management unit 21 manages location information on the mobile body 1, based on the received information relating to a location. When receiving location information on the mobile body 1 from the mobile body 1, the management unit 21 manages the location information.

When receiving location-related information of the mobile body 1 from the mobile body 1, the management unit 21 calculates location information on the mobile body 1 from the location-related information, and manages the calculated location information. Note that the management unit 21 may manage location-related information of the mobile body 1, in place of managing location information on the mobile body 1, and calculate location information on the mobile body 1 as necessary. When receiving a motion model from the mobile body 1, the management unit 21 may calculate a location of the mobile body 1 by using the motion model, and manage the calculated location of the mobile body 1.

After receiving information relating to a location of the mobile body 1 from the mobile body 1, the management unit 21 manages an estimated location of the mobile body 1 estimated by using a predetermined communication model as a location of the mobile body 1 for a period until newly receiving information relating to a location of the mobile body 1 from the mobile body 1.

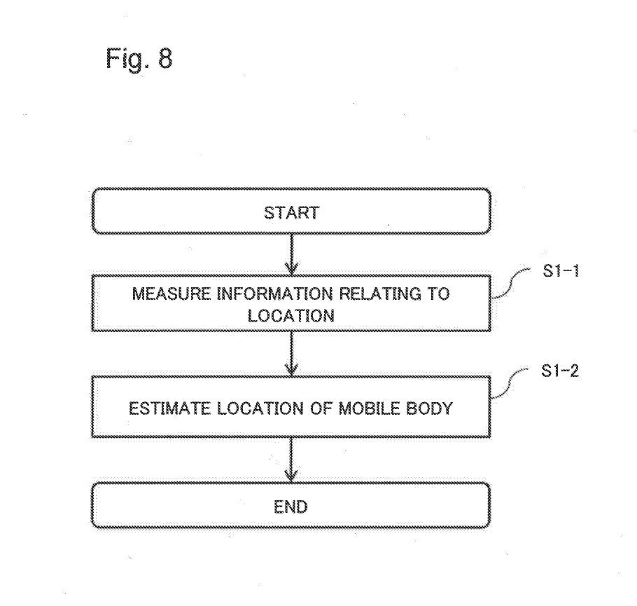

FIG. 8 is a flowchart illustrating an operation example of the mobile body 1 according to the first example embodiment. Note that FIG. 8 is an operation example when the control unit 11 of the mobile body 1 estimates a location of the mobile body 1.

The control unit 11 of the mobile body 1 measures a location of the mobile body 1 (S1-1). The control unit 11 measures a location of the mobile body 1 by a GPS, for example.

The control unit 11 estimates a location of the mobile body 1 after a predetermined time has elapsed by using a motion model, based on information relating to a location of the mobile body 1 (S1-2). The control unit 11 uses a Kalman filter for estimating a location of the mobile body 1, for example. When a Kalman filter is used, the control unit 11 calculates an estimated location of the mobile body 1 after a predetermined time has elapsed, as a motion estimation circle.

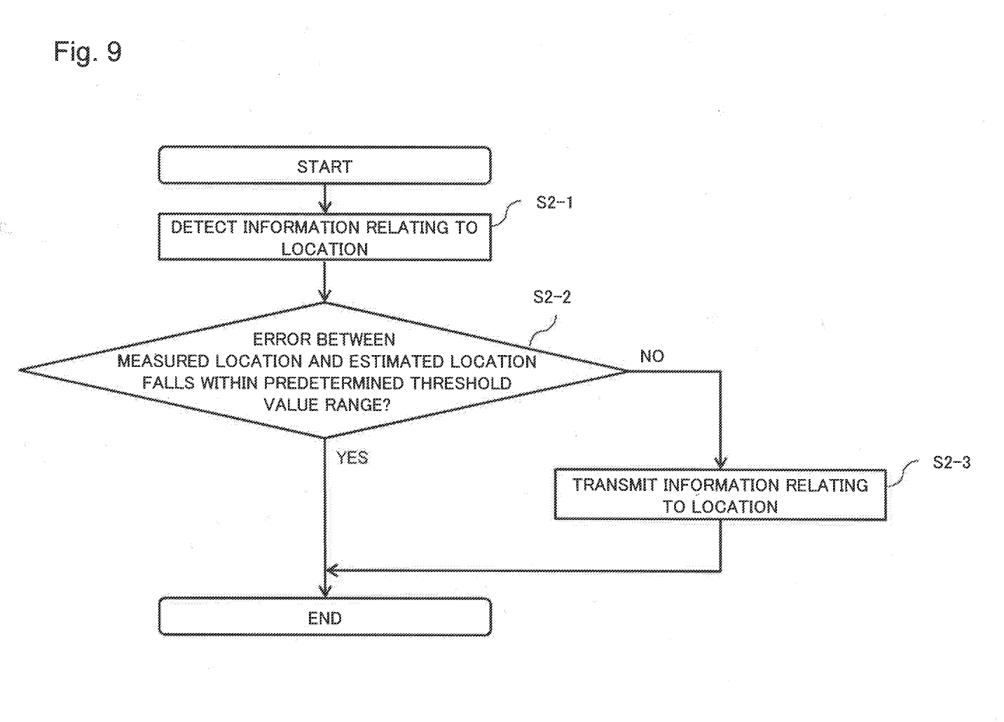

FIG. 9 is a flowchart illustrating another operation example of the mobile body 1 according to the first example embodiment. Note that FIG. 9 is an operation example of the mobile body 1 after a predetermined time has elapsed after the control unit 11 of the mobile body 1 estimates a location of the mobile body 1.

The control unit 11 of the mobile body 1 measures a location of the mobile body 1 (S2-1). The control unit 11 measures a location of the mobile body 1 by a GPS, for example.

The control unit 11 determines whether or not an error between a measured location and an estimated location (estimation location) falls within a predetermined threshold value range (S2-2). The control unit 11 determines whether or not a measured location is within a motion estimation circle estimated by using a Kalman filter, for example. Note that the control unit 11 may determine whether or not an error between a measured location and an estimated location exceeds a predetermined threshold value. Further, the control unit 11 may determine whether or not a measured location falls outside a motion estimation circle estimated by using a Kalman filter, for example.

When it is determined that the error falls within a predetermined threshold value range (“YES” in S2-2), the control unit 11 finishes the processing without notifying the management device 2 of information relating to a location of the mobile body 1. On the other hand, when it is determined that the error exceeds the predetermined threshold value (“NO” in S2-2), the control unit 11 notifies the management device 2 of information relating to a location of the mobile body 1 via the communication unit 10 (S2-3). When a measured location falls outside a motion estimation circle estimated by using a Kalman filter, for example, the control unit 11 notifies the management device 2 of information relating to a location of the mobile body 1.

As described above, when an error between a measured location and an estimated location (estimation location) falls within a predetermined threshold value range, the mobile body 1 does not notify the management device 2 of information relating to a location of the mobile body 1. Consequently, it is possible to prevent an increase in communication traffic, since it is possible to reduce information relating to a location of the mobile body 1, which is transmitted from the mobile body 1 to the management device 2.

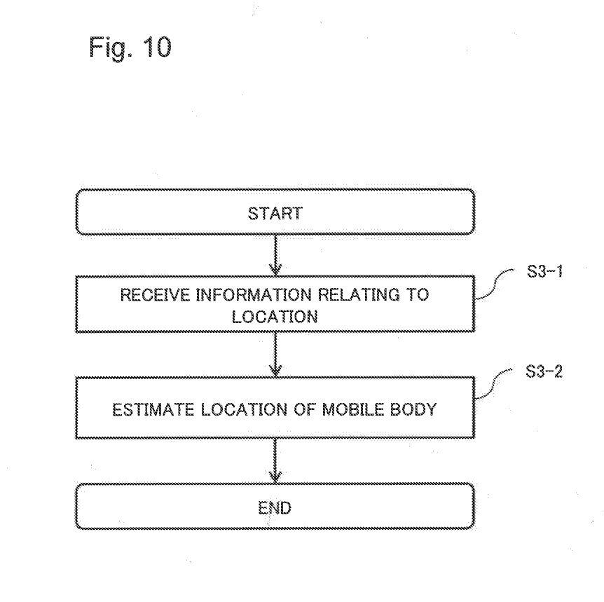

FIG. 10 is a flowchart illustrating an operation example of the management device 2 according to the first example embodiment. Note that FIG. 10 is an operation example when the management device 2 receives information relating to a location from the mobile body 1.

The management unit 21 of the management device 2 receives information relating to a location of the mobile body 1 via the communication unit 20 (S3-1).

The management unit 21 estimates a location of the mobile body 1 after a predetermined time has elapsed by using a motion model, based on the received information relating to a location of the mobile body 1 (S3-2). The management unit 21 calculates a motion estimation circle of the mobile body 1 after a predetermined time has elapsed by using a Kalman filter, for example.

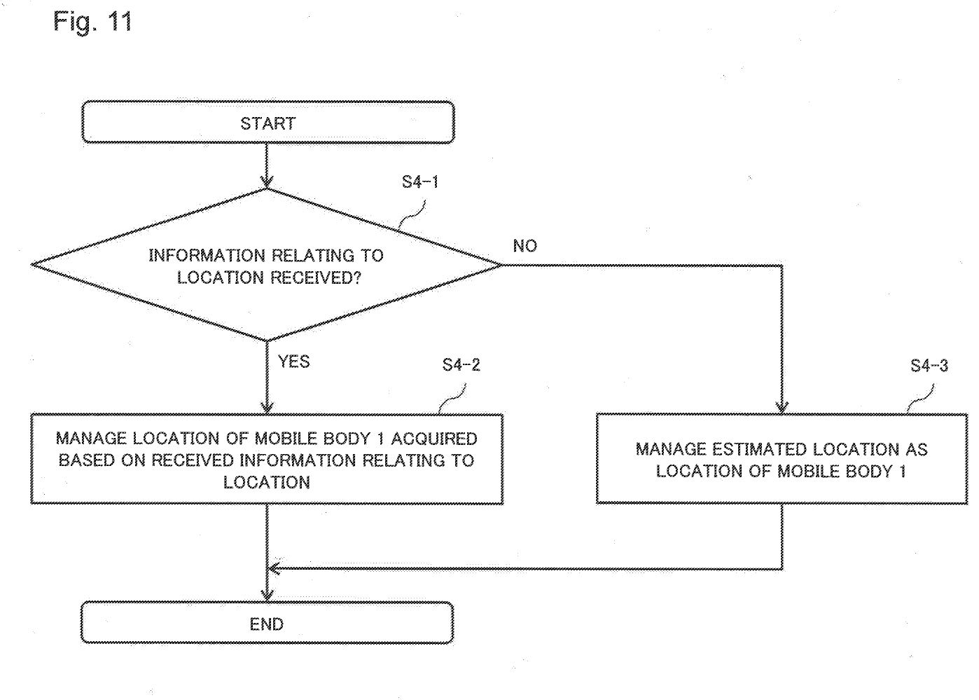

FIG. 11 is a flowchart illustrating another operation example of the management device 2 according to the first example embodiment. Note that FIG. 11 is an operation example of the management device 2 after a predetermined time has elapsed after the management device 2 receives information relating to a location from the mobile body 1.

The management unit 21 of the management device 2 determines whether or not information relating to a location is newly received from the mobile body 1 after a predetermined time has elapsed after receiving information relating to a location from the mobile body 1, for example (S4-1).

When information relating to a location is newly received from the mobile body 1 (“YES” in S4-1), the management unit 21 manages a location of the mobile body 1 acquired based on the newly received information relating to a location (S4-2).

On the other hand, when information relating to a location is not received from the mobile body 1 (“NO” in S4-1), the management unit 21 manages the estimated location of the mobile body 1 estimated in S3-2 in FIG. 10 as a location of the mobile body 1 (S4-3).

As described above, when an error on a location of the mobile body 1 after a predetermined time has elapsed is small compared with an estimated location, the management device 2 manages the estimated location as a location of the mobile body 1. Since an error between an actual location and an estimated location is small, the management device 2 is able to manage the estimated location as a location of the mobile body 1. Further, since the management device 2 manages an estimated location as a location of the mobile body 1, the management device 2 does not have to newly receive notification on location information on the mobile body 1 from the mobile body 1. Therefore, the mobile body 1 does not have to notify the management device 2 of location information on the mobile body 1. This enables to suppress an increase in communication traffic.

### Second Example Embodiment

A second example embodiment of the present invention is an example embodiment in a case where a management device 2 notifies a mobile body 1 of a location of another mobile body 1. Note that a technique of the second example embodiment is applicable to any of the first example embodiment and an example embodiment to be described later.

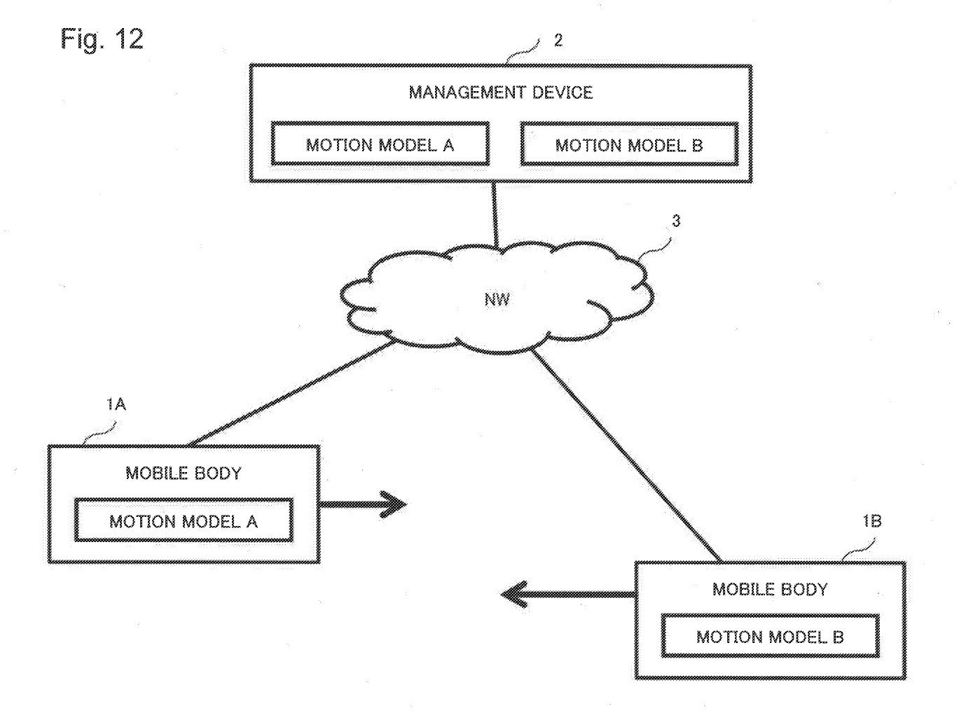

FIG. 12 is a configuration example of a management system according to the second example embodiment. As illustrated in FIG. 12, a second management system includes a plurality of mobile bodies 1 (mobile bodies 1A and 1B), a management device 2, and a NW 3. The management system according to the second example embodiment is such that each of a plurality of mobile bodies 1 transmits and receives information relating to mutual locations via the NW 3 and the management device 2.

The management device 2 holds a motion model associated with each of the plurality of mobile bodies 1. As illustrated in FIG. 12, the management device 2 holds a motion model A with respect to a mobile body 1A, and a motion model B with respect to a mobile body 1B. Note that motion models to be held by the plurality of mobile bodies 1 may be the same each other. In other words, the motion model A to be held by the mobile body 1A, and the motion model B to be held by the mobile body 1B may be the same. In this case, when the management device 2 holds same motion models, it is possible to estimate both locations of the mobile body 1A and the mobile body 1B by the same motion models.

The management device 2 manages each piece of location information on the plurality of mobile bodies 1 (the mobile body 1A and the mobile body 1B). The management device 2 includes a function of notifying each of the plurality of mobile bodies 1 on which location information is managed of location information on another mobile body 1, for example.

When receiving information relating to a location of another mobile body 1 from the management device 2, each of the plurality of mobile bodies 1 notify a user of the mobile body 1 of the location of the another mobile body 1 by displaying the location of the another mobile body 1, for example.

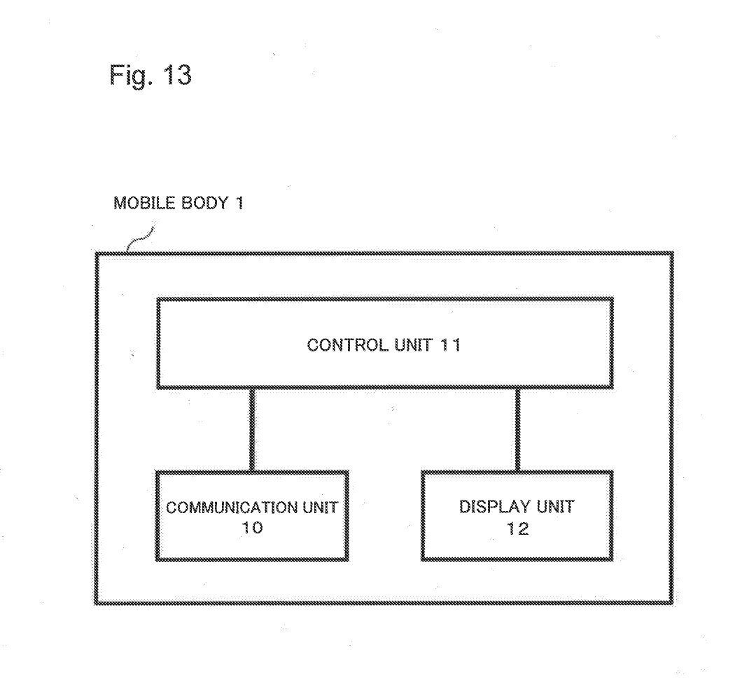

FIG. 13 is a diagram illustrating a configuration example of the mobile body 1 according to the second example embodiment. As illustrated in FIG. 13, the mobile body 1 includes a communication unit 10, a control unit 11, and a display unit 12.

Since the communication unit 10 and the control unit 11 have similar configurations to the communication unit 10 and the control unit 11 of the mobile body 1 according to the first example embodiment illustrated in FIG. 2, detailed description is omitted.

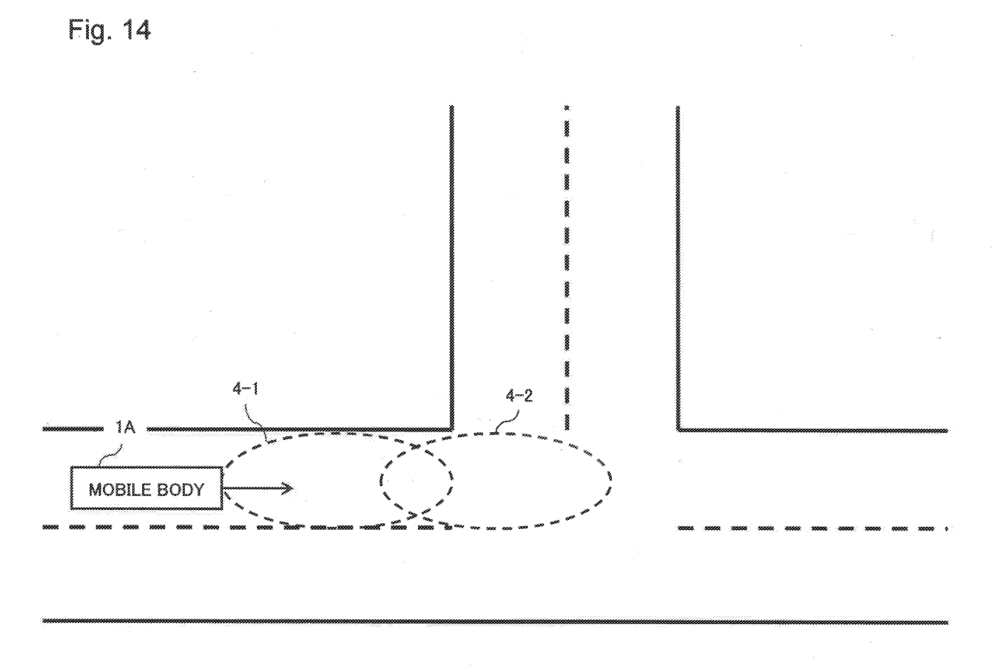

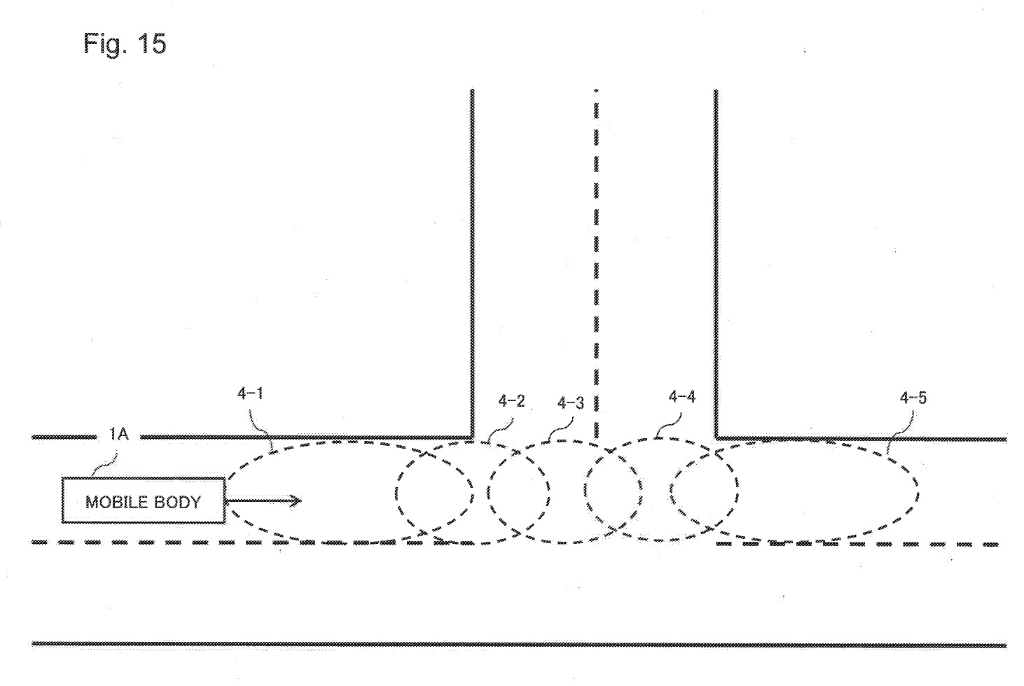

Herein, a location (motion estimation circle) of the mobile body 1 to be estimated by the control unit 11 when the mobile body 1 is an automobile is described by using FIG. 14 and FIG. 15. Note that since the control unit 11 and a management unit 21 of the management device 2 estimate a location of the mobile body 1 by using associated motion models, estimation examples of FIG. 14 and FIG. 15 also illustrate an estimated location (estimation area) of the mobile body 1 to be estimated by the management unit 21.

FIG. 14 is an example of a motion estimation area of the mobile body 1 being an automobile, which is estimated by the control unit 11 and the management unit 21. As illustrated in FIG. 14, the control unit 11 of the mobile body 1 being an automobile estimates a location of the automobile after a predetermined time has elapsed on a road where the automobile travels. As illustrated in FIG. 14, the control unit 11 and the management unit 21 calculate a motion estimation area after a predetermined time has elapsed along a road where the mobile body 1 being an automobile travels. The control unit 11 calculates a motion estimation area 4-1 after a predetermined time “t” has elapsed, and a motion estimation area 4-2 after a predetermined time “2t” has elapsed, for example.

As illustrated in FIG. 14, when the mobile body 1 is an automobile, it is possible to set a motion estimation area of the mobile body 1, as an area on a road where the automobile is allowed to travel. Specifically, the motion estimation area 4-1 is allowed to have a long length in a traveling direction (X direction) of the mobile body 1, and have a fixed length in a road width direction being a direction (Y direction) orthogonal to the traveling direction (specifically, a fixed length in Y direction). Since an automobile normally has a narrow moving range in a road width direction, it is possible to set a motion estimation area as a motion estimation area associated with actual movement of the automobile by narrowing the motion estimation area in the road width direction.

FIG. 15 is another example of a motion estimation area of the mobile body 1 being an automobile, which is estimated by the control unit 11 and the management unit 21. As illustrated in FIG. 15, when the mobile body 1 being an automobile is located near an intersection, the control unit 11 and the management unit 21 estimate a location of the mobile body 1 with a fine granularity by setting an interval of predetermined time “t” short. It is highly likely that the mobile body 1 being an automobile comes close to a pedestrian or another automobile near an intersection, for example. In view of the above, by setting a granularity of a motion estimation area fine near an intersection, it becomes possible to secure accuracy on a location of the mobile body 1 to be managed by the management device 2 by comparing the motion estimation area and an actual location of an automobile at a short interval.

Further, as illustrated in FIG. 15, when the mobile body 1 being an automobile is located near an intersection, the control unit 11 and the management unit 21 may reduce the size itself of a motion estimation area to be estimated. Since the size of a motion estimation area is small, an estimated location of the mobile body 1 comes close to an actual location of the mobile body 1. This enables to secure accuracy on a location of the mobile body 1 to be managed by the management device 2. Further, since an error between an actual location of the mobile body 1, and an estimated location is likely to occur, a frequency at which the mobile body 1 notifies the management device 2 of information relating to a location of the mobile body 1 increases. This enables to secure accuracy on a location of the mobile body 1 to be managed by the management device 2.

Note that a motion estimation area of the mobile body 1 to be estimated by the control unit 11 and the management unit 21 may be set, based on predetermined map information. The control unit 11 and the management unit 21 set a motion estimation area based on a condition of a place where the mobile body 1 is located by using predetermined map information. The control unit 11 and the management unit 21 set a motion estimation area depending on a legal speed limit of a road where the mobile body 1 is located by using predetermined map information, for example. The control unit 11 and the management unit 21 set a motion estimation area of the mobile body 1 being wider, as a legal speed limit increases, for example. The control unit 11 and the management unit 21 set a motion estimation area of the mobile body 1 located near an intersection by using predetermined map information, for example.

The control unit 11 and the management unit 21 set a motion estimation area of the mobile body 1 located near an intersection narrow, for example. The control unit 11 and the management unit 21 set a motion estimation area of the mobile body 1 located on a mountain road by using predetermined map information, for example. The control unit 11 and the management unit 21 set a motion estimation area of the mobile body 1 traveling on a mountain road narrow, for example. The control unit 11 and the management unit 21 may set a motion estimation area of the mobile body 1 by using predetermined map information and traffic congestion information, for example. The control unit 11 and the management unit 21 set a motion estimation area of the mobile body 1 traveling on a congested road narrow, for example.

The management unit 21 of the management device 2 identifies a location of the mobile body 1 on a predetermined map, for example, and notifies the mobile body 1 of predetermined map information by notifying the mobile body 1 of map information at the identified location. Note that the control unit 11 of the mobile body 1 may identify a location of the mobile body 1 on a predetermined map, and notify the management device 2 of map information at the identified location.

The display unit 12 has a function of, when receiving information relating to a location of another mobile body 1 from the management device 2, displaying the location information on the another mobile body 1. The display unit 12 displays location information on an own device and received location information on another mobile body 1 on a map, for example.

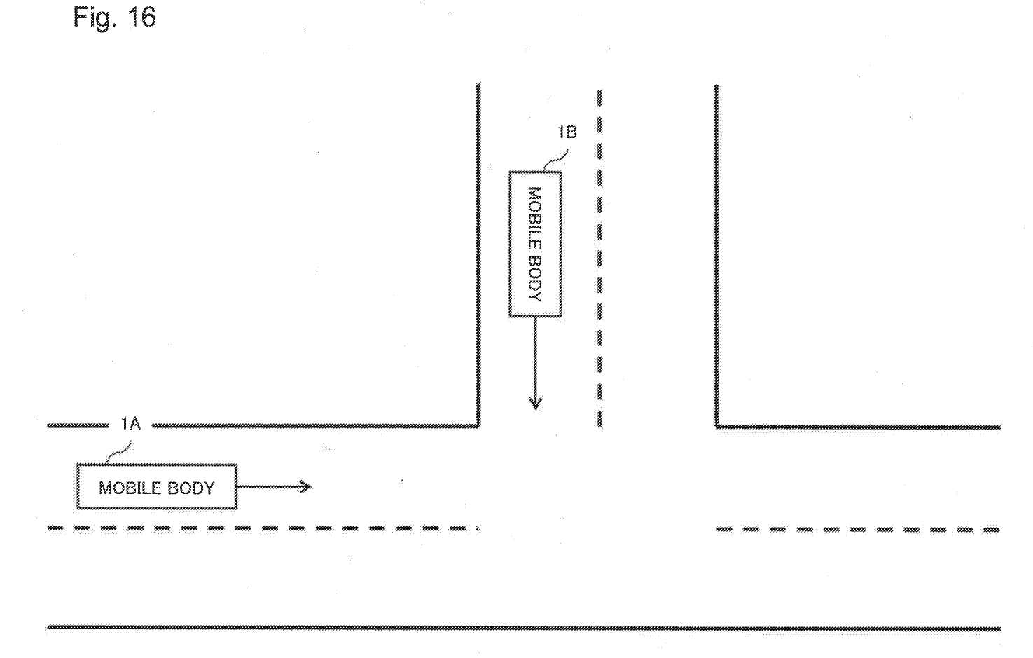

FIG. 16 is a display example when the display unit 12 displays locations of an own device (mobile body 1A) and another mobile body 1B on a map. As illustrated in FIG. 16, since the display unit 12 displays locations of the mobile body 1A and the mobile body 1B on a map, a user of the mobile body 1A is able to grasp that the mobile body 1B is approaching.

Herein, a configuration example of the management device 2 is similar to a configuration example of the management device 2 according to the first example embodiment illustrated in FIG. 7.

The management unit 21 of the management device 2 manages information relating to locations of a plurality of mobile bodies 1, and determines mobile bodies 1 which share information relating to a location, based on the information relating to a location to be managed. The management unit 21 determines the mobile body 1A and the mobile body 1B, as mobile bodies 1 which share location information, based on location information on the mobile body 1A and the mobile body 1B to be managed, for example. The management unit 21 determines mobile bodies 1 at a short distance among a plurality of mobile bodies 1, as mobile bodies 1 which share information relating to mutual locations, for example. When the mobile body 1 is an automobile, for example, the management unit 21 determines a plurality of mobile bodies 1 located near an intersection on a map, as mobile bodies 1 which share information relating to a location. Note that a method of determining mobile bodies 1 which share information relating to a location by the management unit 21 is not limited to a method of determining, based on a distance between mobile bodies 1, but may be any method such as determination based on an attribute of the mobile body 1 and the like, for example.

The management unit 21 notifies each of a plurality of mobile bodies 1 among which location information is determined to be shared, of information relating to a location of another mobile body 1.

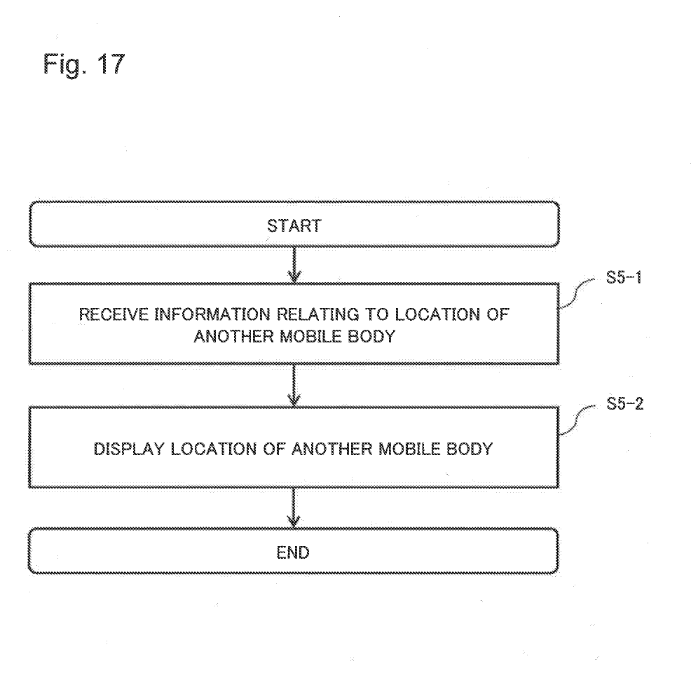

FIG. 17 is a diagram illustrating an operation example of the mobile body 1 according to the second example embodiment. Note that since an operation example when the mobile body 1 estimates a location, and an operation example when the mobile body 1 notifies the management device 2 of information relating to a location are similar to the operation examples illustrated in FIG. 8 and FIG. 9, detailed description is omitted.

The control unit 11 of the mobile body 1 receives, from the management device 2, information relating to a location of another mobile body 1 via the communication unit 10 (S5-1).

The display unit 12 displays the received location of the another mobile body 1 on a map in response to designation from the control unit 11 (S5-2).

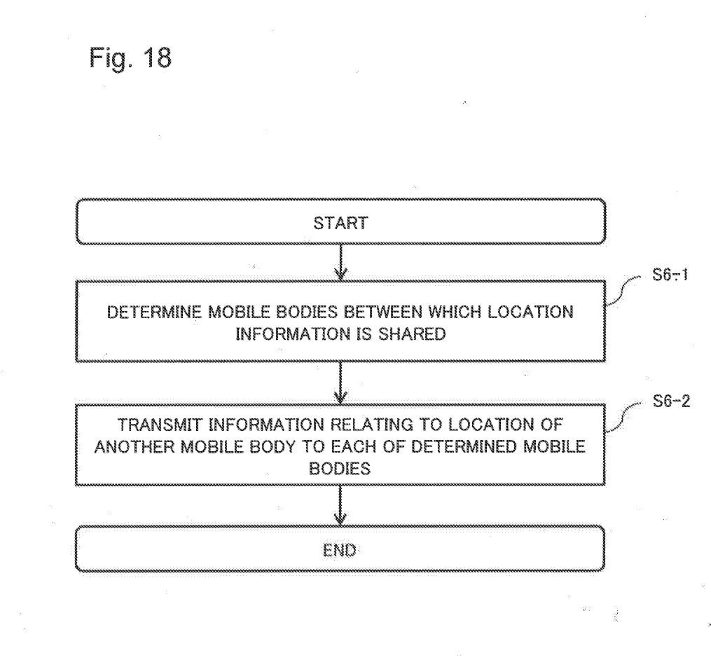

FIG. 18 is a diagram illustrating an operation example of the management device 2 according to the second example embodiment. Note that since an operation example when the management device 2 manages a location, and an operation example when the management device 2 estimates a location of the mobile body are similar to the operation examples illustrated in FIG. 10 and FIG. 11, detailed description is omitted.

The management unit 21 of the management device 2 determines a plurality of mobile bodies 1 among which location information is shared, based on information relating to a location of the mobile body 1 to be managed (S6-1). The management unit 21 determines mobile bodies 1 at a short distance among a plurality of mobile bodies 1, as mobile bodies 1 which share information relating to mutual locations.

The management unit 21 transmits information relating to a location of another mobile body 1 to each of the determined mobile bodies 1 via a communication unit 20 (S6-2).

As described above, since the management device 2 according to the second example embodiment notifies the mobile body 1 of a location of another mobile body 1, a user of the mobile body 1 is able to grasp the another mobile body 1 located near an own device.

### Third Example Embodiment

A third example embodiment of the present invention is an example embodiment in a case where an amount of data to be notified to a management device 2 from a mobile body 1 is reduced. Note that a technique of the third example embodiment is applicable to any of the first and second example embodiments, and example embodiments to be described later.

Since a configuration example of a management system according to the third example embodiment is similar to the configuration example of the management system according to the first example embodiment illustrated in FIG. 1, detailed description thereof is omitted.

The mobile body 1 transmits, to the management device 2, information relating to a velocity of the mobile body 1 as location-related information of an own device. The management device 2 acquires a “velocity” of the mobile body 1, based on information relating to a velocity received from the mobile body 1. The management device 2 uses a “velocity” of the mobile body 1, as a parameter of a motion model for use in estimating a location of the mobile body 1. The management device 2 calculates a location of the mobile body 1, based on a motion model in which a “velocity” of the mobile body 1 is a parameter.

Note that, in the third example embodiment, location-related information of an own device is not limited to information relating to a velocity of the mobile body 1, but may be an acceleration of the mobile body 1. In the following, description is made for a case where location-related information of an own device is information relating to a velocity of the mobile body 1.

In the third example embodiment, as information relating to a velocity, a “code” allocated to the velocity (or a velocity in a predetermined range) is transmitted to the management device 2. For example, when the mobile body 1 is traveling at a velocity of 40 km/h, a code “0010 1000” allocated to the velocity of 40 km/h is transmitted to the management device 2.

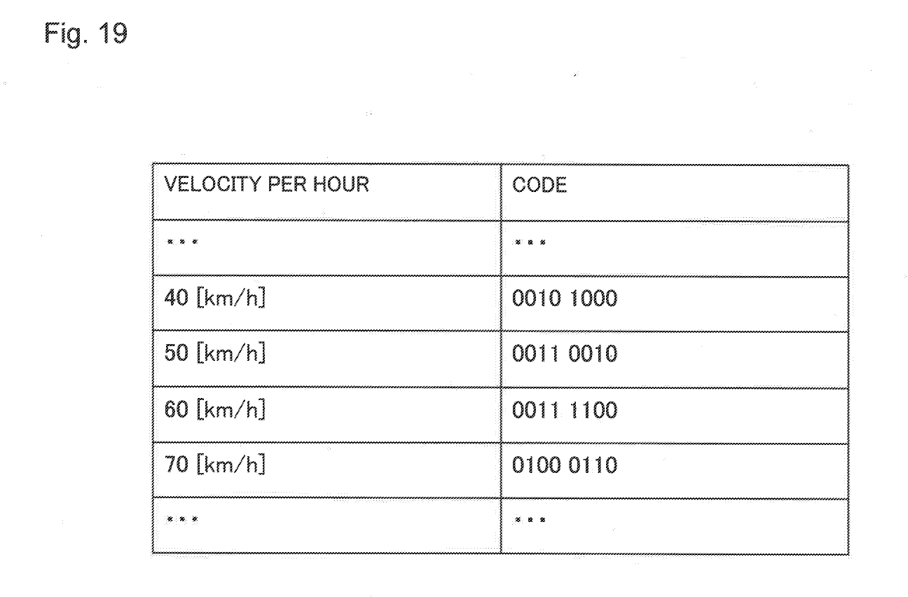

FIG. 19 is a table indicating a velocity, and a code associated with the velocity in the third example embodiment. As illustrated in FIG. 19, for example, a code “0010 1000” is allocated to a velocity of 40 km/h. A code “0011 0010” is allocated to 50 km/h.

A correspondence relationship between a “velocity” and a “code” as illustrated in FIG. 19 is shared by the mobile body 1 and the management device 2. Therefore, when the mobile body 1 transmits a “code” associated with a velocity of an own device to the management device 2, the management device 2 is able to grasp a velocity of the mobile body 1 by referring to the correspondence relationship as illustrated in FIG. 19.

The mobile body 1 measures a velocity of an own device, and notifies the management device 2 of a “code” allocated to a velocity close to the measured velocity among “velocities” in the correspondence relationship in FIG. 19. For example, when the mobile body 1 is traveling at 52 km/h, the mobile body 1 notifies the management device 2 of the code “0011 0010”, which is allocated to 50 km/h close to 52 km/h by referring to the correspondence relationship in FIG. 19.

Note that, in the example of FIG. 19, although a code is allocated to a velocity at an interval of 10 km/h, an interval may be any interval, and a code may be allocated at an interval of 5 km/h, for example.

As described above, in the third example embodiment, by causing the mobile body 1 not to transmit information itself relating to a velocity of an own device, but to transmit a code allocated to the velocity, it is possible to reduce an amount of data to be notified from the mobile body 1 to a management device 2.

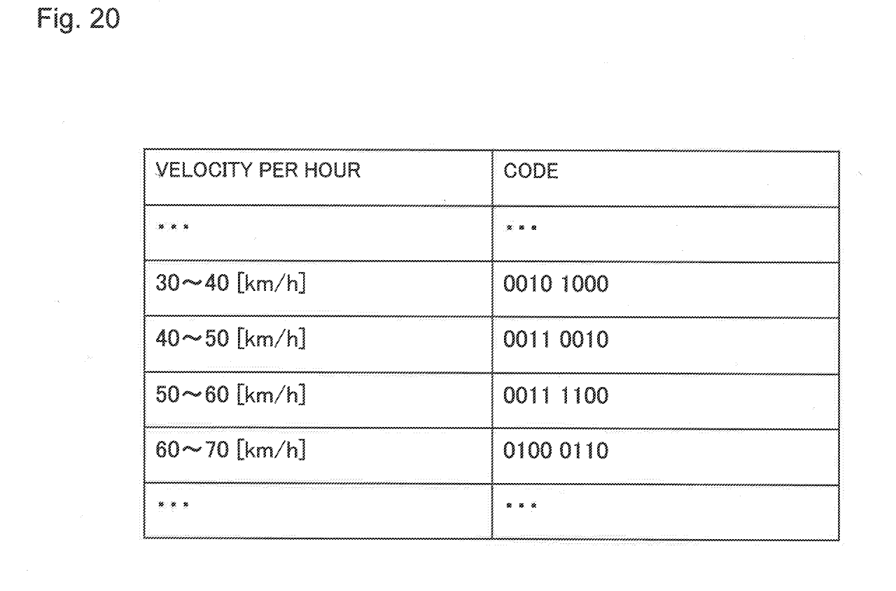

FIG. 20 is a table illustrating a correspondence relationship between a range of velocity, and a code, when a “code” is allocated to the “range of velocity”. As illustrated in FIG. 20, for example, a code “0010 1000” is allocated to a “range of velocity” from 30 to 40 km/h. A code “0011 0010” is allocated to a range of velocity from 40 to 50 km/h.

The mobile body 1 measures a velocity of an own device, and notifies the management device 2 of a “code” allocated to a “range of velocity” including the measured velocity among “ranges of velocity” in the correspondence relationship in FIG. 20. For example, when the mobile body 1 is traveling at 52 km/h, the mobile body 1 notifies the management device 2 of a code “0011 1100”, which is allocated to “50 km/h to 60 km/h” by referring to the correspondence relationship in FIG. 20.

A correspondence relationship between a “range of velocity” and a “code” as illustrated in FIG. 20 is shared by the mobile body 1 and the management device 2. Therefore, by causing the mobile body 1 to transmit a “code” associated with a velocity of an own device to the management device 2, the management device 2 is able to grasp a range of velocity of the mobile body 1 by referring to the correspondence relationship as illustrated in FIG. 20.

Note that, in the example of FIG. 20, a range of velocity is divided in the unit of 10 km/h. The range may be divided in terms of any unit. For example, the range may be divided in the unit of 5 km/h, such as “40 to 45 km/h”.

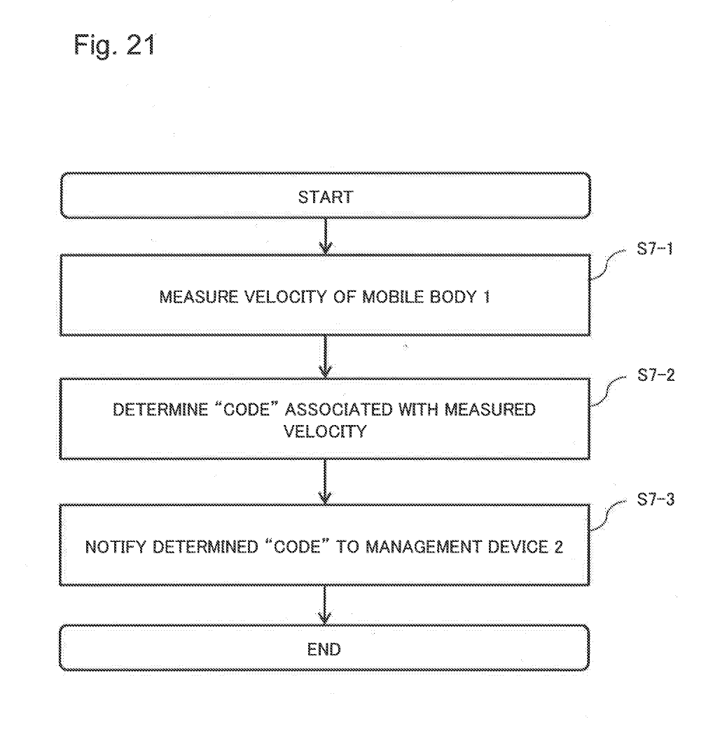

FIG. 21 is a flowchart illustrating an operation example of the mobile body 1 in the third example embodiment.

A control unit 11 of the mobile body 1 measures a velocity of the mobile body 1 (S7-1). The mobile body 1 measures a velocity of an own device by a speed sensor, for example.

The control unit 11 of the mobile body 1 determines a “code” associated with a velocity of an own device by referring to the table illustrating the correspondence relationship in FIG. 19 or FIG. 20 held by the own device (S7-2).

A communication unit 10 of the mobile body 1 notifies the management device 2 of the determined “code” (S7-3).

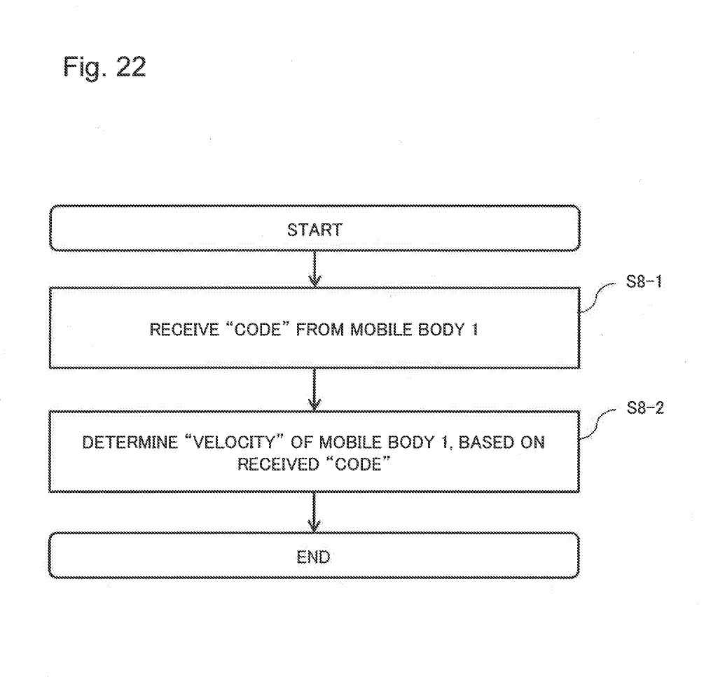

FIG. 22 is a flowchart illustrating an operation example of the management device 2 according to the third example embodiment. Note that FIG. 22 is an operation example of a case where a velocity of a mobile body 1 is determined, when the management device 2 receives a “code” from the mobile body 1.

A communication unit 20 of the management device 2 receives a “code” from the mobile body 1 (S8-1).

A management unit 21 of the management device 2 determines a “velocity” (or a “range of velocity”) of the mobile body 1, based on the received “code”, by referring to the table illustrating the correspondence relationship in FIG. 19 or FIG. 20 held by the own device (S8-2).

As described above, since the mobile body 1 notifies a management device of, as information relating to a velocity of an own device, a code allocated to the velocity (or a range of velocity), it is possible to reduce an amount of data to be notified from the mobile body 1 to the management device 2.

### Fourth Example Embodiment

A fourth example embodiment according to the present invention is an example embodiment in a case where a short code as compared with other velocity, specifically, a code having a small amount of data, is allocated to a velocity having a high frequency of appearance as a velocity of a mobile body 1 depending on a history on a velocity of the mobile body 1 or a characteristic of the mobile body 1. Note that a technique of the fourth example embodiment is applicable to any of the first to third example embodiments, and example embodiments to be described later.

Since a configuration example of a management system according to the fourth example embodiment is similar to the configuration example of the management system according to the first example embodiment illustrated in FIG. 1, detailed description thereof is omitted.

The mobile body 1 transmits, to a management device 2, information relating to a velocity of the mobile body 1, as location-related information of an own device. In the fourth example embodiment, as information relating to a velocity, a “code” allocated to the velocity (or a range of velocity) is transmitted to the management device 2.

In the fourth example embodiment, a short code as compared with other velocity is allocated to a velocity having a high frequency of appearance, as a velocity of the mobile body 1.

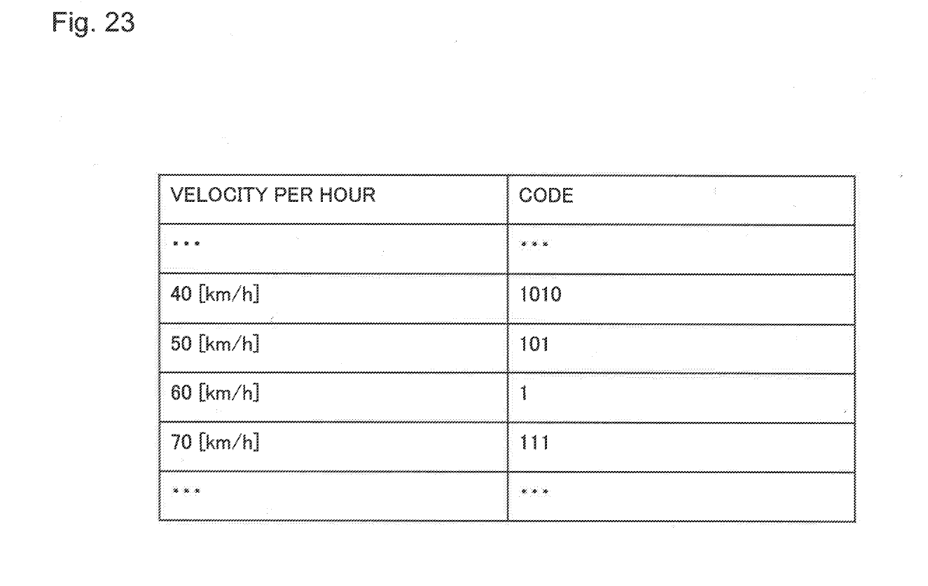

FIG. 23 is a table indicating a velocity, and a code associated with the velocity in the fourth example embodiment. FIG. 23 illustrates a correspondence relationship between a velocity, and a code allocated to the velocity, when a frequency at which the mobile body 1 travels at 60 km/h (or a velocity close to 60 km/h) is high.

As illustrated in FIG. 23, for example, a code “1010” is allocated to a velocity of 40 km/h. On the other hand, a code “101” is allocated to 50 km/h. Further, a code “1” is allocated to 60 km/h. In this way, in the example of FIG. 23, a short code is allocated to a velocity at which the mobile body 1 travels at a high frequency.

Since a frequency at which the mobile body 1 travels at 60 km/h is high, a case that a code “1” is transmitted to the management device 2 by referring to the correspondence relationship illustrated in FIG. 23 increases. Therefore, it is possible to reduce an amount of data to be transmitted from the mobile body 1 to the management device 2.

A correspondence relationship between a “range of velocity” and a “code” as illustrated in FIG. 23 is shared by the mobile body 1 and the management device 2. Therefore, by causing the mobile body 1 to transmit a “code” associated with a velocity of an own device to the management device 2, the management device 2 is able to grasp a range of velocity of the mobile body 1 by referring to the correspondence relationship as illustrated in FIG. 23.

It is possible to determine a velocity having a high frequency of appearance, as a velocity of the mobile body 1, based on a history on a velocity of the mobile body 1 in the past, for example. For example, an average moving velocity of the mobile body 1 in a predetermined period is determined as a velocity of the mobile body 1 having a high frequency of appearance. More specifically, an average moving velocity of the mobile body 1 for one month in the past is determined as a velocity of the mobile body 1 having a high frequency of appearance, and a short code as compared with other velocity is allocated to the velocity. Further, a shorter “code” is allocated, as a velocity approaches the average moving velocity. Note that a range of history is not limited to one month, and any range such as one week, one day, or one hour is applicable.

Further, a velocity having a high frequency of appearance as a velocity of the mobile body 1 may not be an average moving velocity of the mobile body 1. For example, a short code as compared with other velocity may be allocated to a velocity at which the mobile body 1 traveled for a longer time among velocities at which the mobile body 1 actually traveled. For example, for one month in the past, in a case where a time during which the mobile body 1 traveled at 40 km/h (or a velocity close to 40 km/h) is fifteen hours, a time during which the mobile body 1 traveled at 50 km/h (or a velocity close to 50 km/h) is twenty-seven hours, and a time during which the mobile body 1 traveled at 60 km/h (or a velocity close to 60 km/h) is twelve hours, a shorter code as compared with the other velocities is allocated to 50 km/h.

Further, when the mobile body 1 is an automobile, a velocity to which a short code is allocated may be changed depending on a driver driving the automobile. For example, in a case of an elderly driver, a short code may be allocated to 40 km/h, and in a case of a young driver, a short code may be allocated to 60 km/h.

Further, a velocity to which a short code is allocated may be changed depending on a place where the mobile body 1 is moving.

For example, when an automobile being the mobile body 1 travels on a highway, a short code may be allocated to 80 km/h, and when the automobile travels on an open road, a short code may be allocated to 60 km/h.

Herein, a place where the mobile body 1 is moving may be such that whether an automobile being the mobile body 1 is traveling on a straight road, or is traveling around an intersection, for example. Further, a place where the mobile body 1 is moving may be a difference in distance from an intersection such that whether the mobile body 1 is located at a location 100 [m] before an intersection, or enters an intersection. Further, a place where the mobile body 1 is moving may be a difference in lane such that whether the mobile body 1 is traveling on a passing lane, or is traveling on a driving lane among a plurality of lanes of a road, for example.

Further, a place where the mobile body 1 is moving may be a difference in country or a difference in administrative region such that the mobile body 1 is moving in which “country”, is moving in which “state”, or is moving in which “city, town, or village”, for example.

Further, a place where the mobile body 1 is moving may be a difference in condition of a place where the mobile body 1 is moving such that whether the mobile body 1 is moving on a downhill, is moving on a flat road, or is moving on an uphill, for example. Further, a place where the mobile body 1 is moving may be a difference identifiable by referring to map information, for example. A place where the mobile body 1 is moving may be a difference such that whether or not the mobile body 1 is moving around an elementary school, is moving around a thickly housed area, or is moving around a busy street, for example.

Further, a velocity to which a short code is allocated may be changed depending on a traveling time zone of the mobile body 1. For example, when an automobile being the mobile body 1 is traveling in a time zone when traffic is heavy (e.g., in the evening), since it is predicted that a velocity of the mobile body 1 becomes slow, a short code is allocated to 40 km/h, for example. On the other hand, when an automobile being the mobile body 1 is traveling in a time zone when traffic is light (e.g., late at night), since it is predicted that a velocity of the mobile body 1 becomes fast, a short code is allocated to 60 km/h, for example.

Further, a velocity to which a short code is allocated may be changed, based on a weather (such as a fine weather, a rainy weather, and a snowy weather), and a condition of a road surface (such as a paved road surface, an unpaved road surface, a road surface covered with snow, and a frozen road surface), for example. For example, a velocity to which a short code is allocated may be changed depending on a weather such that, when the weather is fine, a short code is allocated to 60 km/h, and when the weather is rainy, a short code is allocated to 40 km/h.

Note that the mobile body 1 and the management device 2 interchange a “code” and a “velocity” (or a “range of velocity”), based on a same correspondence relationship. Therefore, when a correspondence relationship between a “code” and a “velocity” (or a “range of velocity”) is changed either in the mobile body 1 or the management device 2, it is necessary to notify the other of the mobile body 1 and the management device 2 of the change. For example, when the mobile body 1 changes a correspondence relationship between a “code” and a “velocity” (or a “range of velocity”), the mobile body 1 notifies the management device 2 of the correspondence relationship after the change. The management device 2 determines a “velocity” (or a “range of velocity”) from a “code” received from the mobile body 1 by referring to the correspondence relationship after the change.

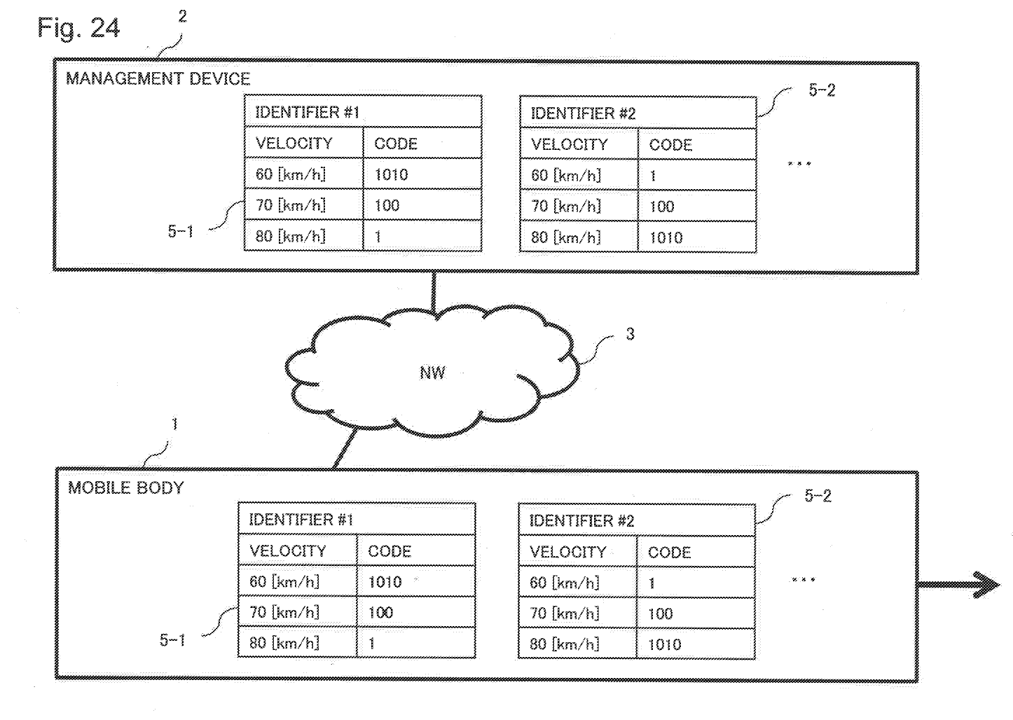

Further, as illustrated in FIG. 24, the mobile body 1 and the management device 2 may hold a plurality of correspondence relationships between a velocity and a code. In this case, the mobile body 1 and the management device 2 interchange a correspondence relationship to be used depending on a predetermined condition. For example, when the mobile body 1 being an automobile travels on a highway, a correspondence relationship 5-1 in which a short code is allocated to 80 km/h is used; and when the mobile body 1 travels on an open road, a correspondence relationship 5-2 in which a short code is allocated to 60 km/h is used. When the mobile body 1 changes a correspondence relationship to be used, the mobile body 1 notifies the management device 2 of an identifier indicating the correspondence relationship after the change. For example, when the mobile body 1 changes a correspondence relationship to be used from the correspondence relationship 5-1 to the correspondence relationship 5-2, the mobile body 1 notifies the management device 2 of #2 being an identifier of the correspondence relationship after the change. By causing the mobile body 1 to notify an identifier of a correspondence relationship to be used, the management device 2 is able to determine a “velocity” from a “code” by referring to a correspondence relationship associated with the identifier.

Further, in a condition that the mobile body 1 and the management device 2 hold a plurality of correspondence relationships, when a policy regarding changing the correspondence relationship is determined in advance, each of the mobile body 1 and the management device 2 may interchange a correspondence relationship depending on the policy. In this case, since a policy regarding changing is determined in advance, it is possible to individually change a correspondence relationship without mutually notifying an identifier of the correspondence relationship.

For example, the mobile body 1 and the management device 2 share a policy regarding changing a correspondence relationship. A policy regarding changing is a policy such that a correspondence relationship is changed, based on an average value of a velocity of the mobile body 1 within a predetermined time, for example.

Herein, when an average velocity of the mobile body 1 within one hour in the past is 78 km/h, in FIG. 24, using the correspondence relationship 5-1 than using the correspondence relationship 5-2 enables to reduce an amount of data between the mobile body 1 and the management device 2. When the correspondence relationship 5-2 is used, a frequency at which the mobile body 1 having an average velocity of 78 km/h transmits a code “1010” to the management device 2 increases. On the other hand, when the correspondence relationship 5-1 is used, the mobile body 1 having an average velocity of 78 km/h is only required to transmit a code “1” to the management device 2, and it is possible to reduce an amount of data to be transmitted, as compared with a case where the correspondence relationship 5-2 is used.

Further, the mobile body 1 and the management device 2 may change a correspondence relationship independently of each other, based on an average velocity of the mobile body 1 within a predetermined time, by sharing a policy to be used when a correspondence relationship is changed. Specifically, the mobile body 1 using the correspondence relationship 5-2 changes a correspondence relationship to be used to the correspondence relationship 5-1, based on an average velocity of an own device within one hour in the past being 78 km/h. On the other hand, the management device 2 using the correspondence relationship 5-2 calculates or estimates that an average velocity of the mobile body 1 within one hour in the past is 78 km/h, and changes a correspondence relationship to be used to the correspondence relationship 5-1. Note that the management device 2 calculates an average velocity of the mobile body 1 within a predetermined time, based on information relating to a location of the mobile body 1 received from the mobile body 1. Further, the management device 2 estimates an average velocity of the mobile body 1 within a predetermined time by using a motion model, based on received information relating to a location of the mobile body 1.

A policy regarding changing a correspondence relationship is not limited to such that “changing a correspondence relationship, based on an average velocity of the mobile body 1 within a predetermined time”, but may be any policy.

For example, a policy regarding changing a correspondence relationship may be a policy such that “changing a correspondence relationship, based on a velocity having a high frequency of appearance among velocities of the mobile body 1 within a predetermined time”. For example, when an average velocity of the mobile body 1 within one hour in the past is 73 km/h, but a velocity having a high frequency of appearance is 80 km/h (e.g., the mobile body 1 travels at 80 km/h for forty-five minutes within one hour), a correspondence relationship is changed to an appropriate correspondence relationship (e.g., a correspondence relationship in which a code associated with 80 km/h is a “short code”), based on the velocity of 80 km/h having a high frequency of appearance.

As described above, by causing the mobile body 1 and the management device 2 to share a policy to be used when a correspondence relationship is changed, the mobile body 1 and the management device 2 are able to change a correspondence relationship independently of each other. Therefore, the mobile body 1 and the management device 2 do not have to mutually notify an identifier of a correspondence relationship to be used, and it becomes possible to reduce an amount of data to be transmitted and received.

Further, in the fourth example embodiment, the mobile body 1 and the management device 2 may identify which one of mutually shared correspondence relationships is used from predetermined information in accordance with a mutually same algorithm (specifying method). The mobile body 1 and the management device 2 may identify which one of a plurality of shared correspondence relationships is used in accordance with a mutually same algorithm (specifying method) by using a type of road, a time zone, a congestion condition, and the like, for example. Since the mobile body 1 and the management device 2 use a mutually same algorithm (specifying method), correspondence relationships to be identified by the mobile body 1 and the management device 2 become same correspondence relationships.

Information for use in identifying a correspondence relationship to be used is information that affects a velocity of the mobile body 1, such as a type of road on which the mobile body 1 travels (whether a road is a highway or an open road, and the like), a time zone (whether time is in the morning or in the afternoon, and the like), and a congestion condition (degree of congestion), for example. Note that information for use in identifying a correspondence relationship to be used is not limited to these examples. As far as information is information that affects a velocity of the mobile body 1, any information such as a condition of a road surface (whether or not a road surface is wet, and the like) may be used, for example. Further, information for use in identifying a correspondence relationship to be used may differ in terms of degree of consideration. For example, when “congestion information” is an index having a high degree of preference as compared with a “time zone”, weighting may be performed in such a way that congestion information is made more important than a time zone, when a correspondence relationship to be used is identified.

The mobile body 1 and the management device 2 may identify a correspondence relationship to be used by combining a part of a plurality of pieces of information such as congestion information, a time zone, and a type of road. For example, the mobile body 1 and the management device 2 may identify a correspondence relationship to be used from a type of road and a time zone.

The mobile body 1 is notified of congestion information from the management device 2. The management device 2 calculates a degree of congestion (congestion information) around the mobile body 1 from the number of other mobile bodies 1 around the mobile body 1, and notifies the mobile body 1 of the calculated degree of congestion. Further, the mobile body 1 and the management device 2 may receive congestion information from another device (not illustrated in the drawings) which collects congestion information.

As described above, the fourth example embodiment of the present invention allocates a short code as compared with other velocity, specifically, a code having a small amount of data, to a velocity having a high frequency of appearance as a velocity of the mobile body 1 depending on a history on a velocity of the mobile body 1 and a characteristic of the mobile body 1. Therefore, it becomes possible to reduce an amount of data to be transmitted and received between the mobile body 1 and the management device 2.

### Fifth Example Embodiment

A fifth example embodiment according to the present invention is an example embodiment, in which, by allocating a “code” to a movement of a predetermined mobile body 1, it becomes possible to reduce a frequency and an amount of information (amount of data) regarding information relating to a location of the mobile body 1 to be transmitted from the mobile body 1 to a management device 2. Note that a technique of the fifth example embodiment is applicable to any of the first to fourth example embodiments.

Since a configuration example of a management system according to the fifth example embodiment is similar to the configuration example of the management system according to the first example embodiment illustrated in FIG. 1, detailed description thereof is omitted.

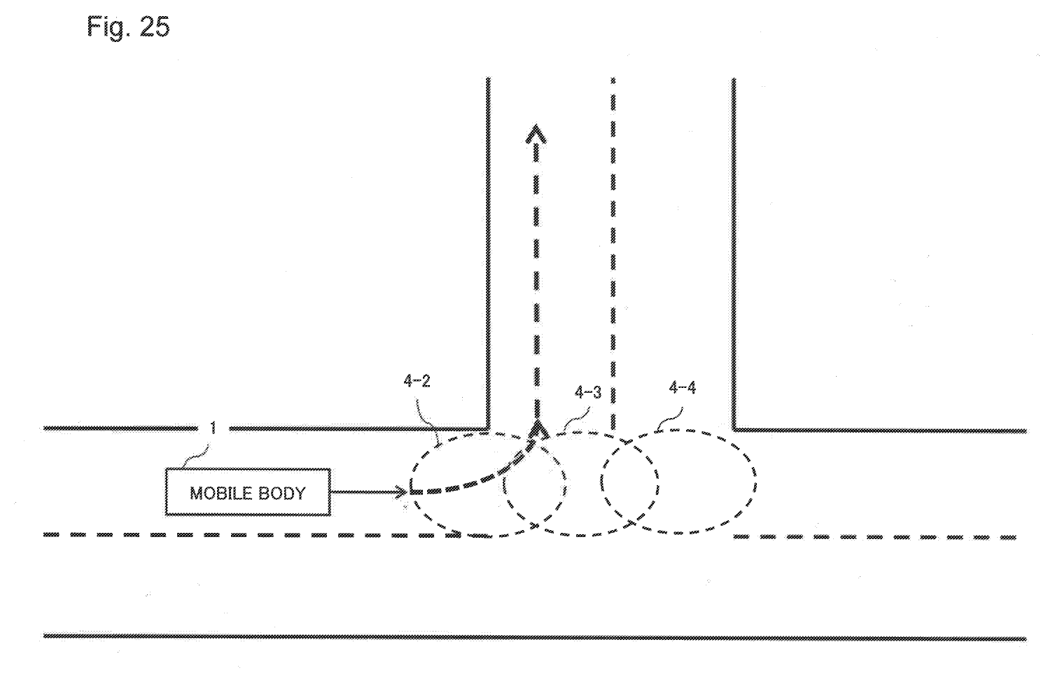

The mobile body 1 notifies the management device 2 of a location of an own device, when the location of the own device is deviated from a motion estimation circle estimated by using a motion model. For example, as illustrated in FIG. 25, when the mobile body 1 being an automobile turns at an intersection, it is predicted that a location of the mobile body 1 is frequently deviated from a motion estimation circle (e.g., a motion estimation circle 4-2 or 4-3). In this case, the mobile body 1 is required to transmit a location of an own device to the management device 2 at a short interval. Then, a frequency of information and an amount of data to be transmitted from the mobile body 1 to the management device 2 increase.

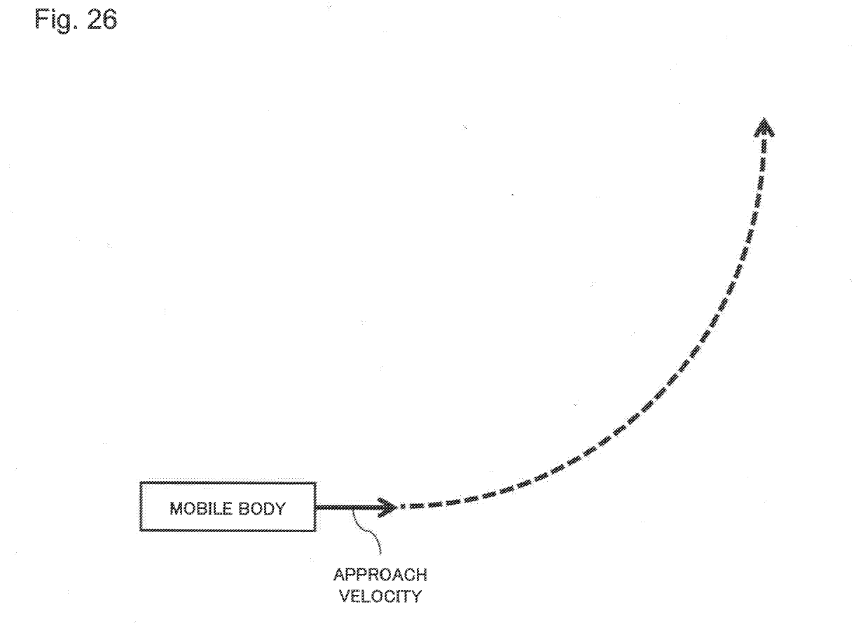

On the other hand, when the mobile body 1 turns at an intersection, a locus of the mobile body 1 is substantially constant from a weight and an approach velocity of the mobile body 1. As illustrated in FIG. 26, a locus of the mobile body 1 becomes substantially constant from a weight of the mobile body 1, an approach velocity of the mobile body 1, and a turning direction of the mobile body 1.

In view of the above, a locus of the mobile body 1 when the mobile body 1 turns at an intersection is formed into a pattern, and a “code” is associated with the locus pattern. Further, the mobile body 1 and the management device 2 share a correspondence relationship between a locus pattern and a code. Then, when turning at an intersection, the mobile body 1 detects a velocity of an own device, identifies a locus pattern, based on the detected velocity, and notifies the management device 2 of a code associated with the identified pattern. The management device 2 is able to identify a locus pattern of the mobile body 1, based on a correspondence relationship shared with the mobile body 1 from the notified code. Consequently, since the mobile body 1 is only required to notify a code at least until turning the intersection, the mobile body 1 does not have to notify the management device 2 of a location of an own device at a short interval, and it becomes possible to reduce an amount of information to be notified to the management device 2.

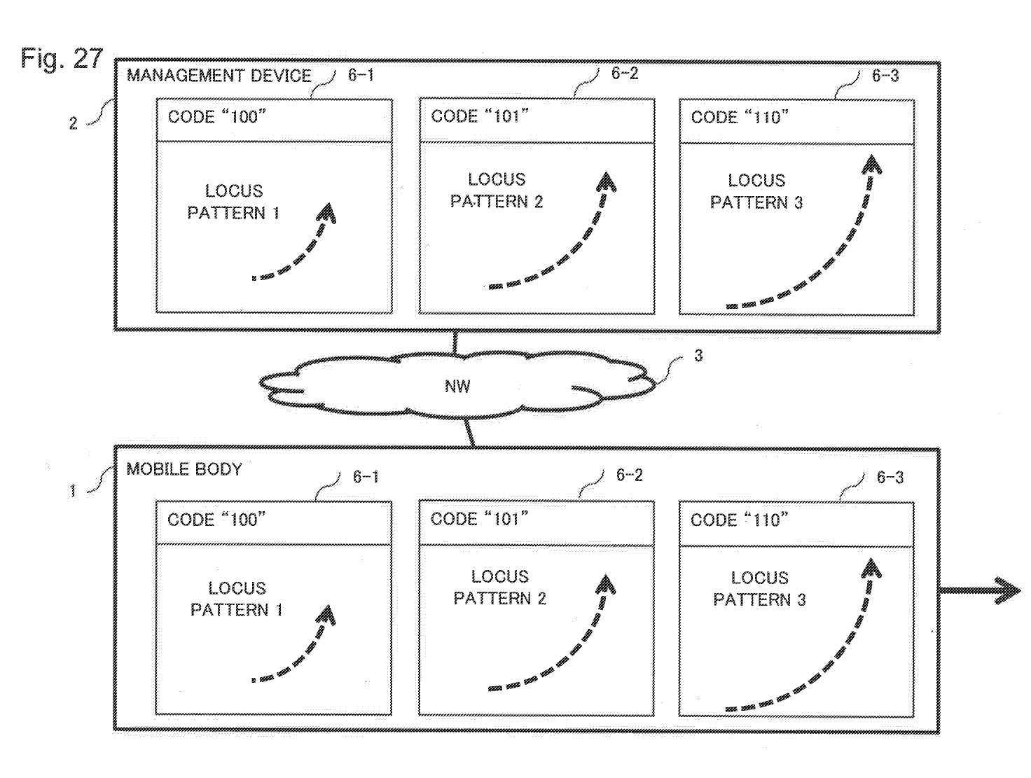

As illustrated in FIG. 27, for example, the mobile body 1 and the management device 2 share a correspondence relationship in which a locus pattern and a code are associated. As illustrated in FIG. 27, for example, the mobile body 1 and the management device 2 share correspondence relationships 6-1, 6-2, and 6-3 between a locus pattern and a code. The mobile body 1 identifies a locus pattern of the mobile body 1 from a weight of an own device, an approach velocity with respect to an intersection, a turning direction, and the like. The mobile body 1 notifies the management device 2 of a code associated with an identified locus pattern. The mobile body 1 identifies a locus pattern of an own device as a “locus pattern 1”, and notifies the management device 2 of an associated code “100”. The management device 2 is able to identify that the mobile body 1 is moving by the locus pattern 1, based on the code “100” notified from the mobile body 1. Therefore, the mobile body 1 does not have to notify the management device 2 of a location of an own device at a short interval. Further, it is also possible to reduce an amount of information to be notified from the mobile body 1 to the management device 2.

Further, in the fifth example embodiment, the mobile body 1 may notify the management device 2 of information relating to an error between an identified locus pattern, and an actual location (detected location) of an own device. In this case, the management device 2 is able to calculate an accurate location of the mobile body 1, as a location of the mobile body 1, from information relating to an error received from the mobile body 1, and a locus pattern.

Further, in the fifth example embodiment, the mobile body 1 and the management device 2 may calculate a motion estimation area in conformity with a locus pattern, as a motion estimation area of the mobile body 1 after a predetermined time has elapsed. Since a motion estimation area in conformity with a locus pattern is calculated, it is less likely that an actual location (detected location) of the mobile body 1 is deviated from a motion estimation area, and it is possible to reduce a frequency at which the mobile body 1 notifies the management device 2 of information relating to a location. Consequently, it becomes possible to reduce an amount of data of information to be transmitted and received between the mobile body 1 and the management device 2. Note that the mobile body 1 and the management device 2 may change a shape of a motion estimation area of the mobile body 1, based on an identified locus pattern.

Note that, in the above-described example, a locus of the mobile body 1 is formed into a pattern regarding a case where the mobile body 1 being an automobile turns at an intersection. A movement of the mobile body 1, however, is not limited to the above example, and any case may be considered. For example, a movement of the mobile body 1 being a drone, when the mobile body 1 turns right or left, may be formed into a pattern. In this case, the mobile body 1 and the management device 2 share a correspondence relationship in which a turning pattern and a code are associated.

Further, the mobile body 1 and the management device 2 share a function for calculating a locus of the mobile body 1, for example. The mobile body 1 and the management device 2 calculate a locus of the mobile body 1 independently of each other by using a shared function. A function calculates a locus of the mobile body 1 by giving a parameter such as information depending on a weight and a velocity of the mobile body 1, and a type of mobile body 1, for example. A parameter for calculating a locus may be any information, as far as the information is information such as a weight and a velocity of the mobile body 1, a condition of a road surface on which the mobile body 1 is traveling, a type of tires of the mobile body 1, and a tread width and a wheel base of the mobile body 1, and capable of calculating a locus of the mobile body 1, for example.

Since the mobile body 1 and the management device 2 share a function, and a locus pattern of the mobile body 1 can be calculated by inputting a weight and a velocity of the mobile body 1, and other information, it is not necessary to share a locus pattern in advance.

As described above, by allocating a “code” to a movement of a predetermined mobile body 1, it is possible to reduce a frequency and an amount of information (amount of data) regarding information relating to a location of the mobile body 1, which is transmitted from the mobile body 1 to the management device 2.

Further, in the present invention, the mobile body 1, a computer of the management device 2, a central processing unit (CPU), a micro-processing unit (MPU), or the like may execute a software (program) for implementing functions of each of the above-described example embodiments. The mobile body 1 and the management device 2 may acquire a software (program) for implementing functions of each of the above-described example embodiments via various storage media such as a compact disc recordable (CD-R) or a network, for example. A program to be acquired by the mobile body 1 and the management device 2, and a storage medium storing the program constitute the present invention. Note that the software (program) may be stored in advance in a predetermined storage unit included in the mobile body 1 and the management device 2, for example. The mobile body 1 or a computer of each network node, a CPU, an MPU, or the like may read and execute program codes of an acquired software (program). Therefore, the mobile body 1 and the management device 2 execute same processing as the processing of the mobile body 1 and the management device 2 according to each of the above-described example embodiments.

In the foregoing, example embodiments of the present invention are described. The present invention, however, is not limited to each of the above-described example embodiments. The present invention is implementable, based on modifications/replacements/adjustments of each of the example embodiments. Further, the present invention is implementable by optionally combining each of the example embodiments. Specifically, the present invention includes various modifications and revisions capable of being implemented in accordance with all contents of disclosure and technical ideas of the present specification. Further, the present invention is also applicable to a technical field of a software-defined network (SDN).

While the invention has been particularly shown and described with reference to example embodiments thereof, the invention is not limited to these embodiments. It will be understood by those of ordinary skill in the art that various changes in form and details may be made therein without departing from the spirit and scope of the present invention as defined by the claims.

This application is based upon and claims the benefit of priority from Japanese patent application No. 2016-090061, filed on Apr. 28, 2016, the disclosure of which is incorporated herein in its entirety by reference.

### SUPPLEMENTARY NOTE

The whole or part of the example embodiments disclosed above can be described as, but not limited to, the following supplementary notes.

### (Supplementary Note 1)

A management system including:

a mobile body for estimating a location of an own device after a predetermined time elapses by using a predetermined motion model, based on a velocity of the own device; and

a management device for estimating a location of the mobile body after the predetermined time elapses, by using the predetermined motion model, based on information relating to a velocity of the mobile body, wherein

the mobile body transmits, to the management device, information relating to a velocity of an own device in response to an error exceeding a predetermined threshold value, the error being between a location of an own device measured after a predetermined time elapses, and the estimated location of the own device.

### (Supplementary Note 2)

The management system according to Supplementary Note 1, wherein

the mobile body stores a correspondence relationship between each of a plurality of velocities, and a predetermined code, and transmits a code associated with a velocity of an own device to the management device.

### (Supplementary Note 3)

The management system according to Supplementary Note 2, wherein

the mobile body stores a short code in association with a velocity having a high frequency of appearance within a velocity of an own device.

### (Supplementary Note 4)

The management system according to Supplementary Note 2 or 3, wherein

the mobile body stores a short code in association with an average velocity of the mobile body in a predetermined period.

### (Supplementary Note 5)

The management system according to any one of Supplementary Notes 2 to 4, wherein

the mobile body changes a correspondence relationship between each of a plurality of velocities, and a predetermined code, depending on a characteristic of the mobile body.

### (Supplementary Note 6)

A mobile body including:

first means for transmitting information relating to a velocity of an own device to a management device; and

second means for estimating a location of an own device after a predetermined time elapses, by using a predetermined motion model, based on a velocity of the own device, wherein

the second means transmits, to the management device, information relating to a velocity of the own device via the first means in response to an error exceeding a predetermined threshold value, the error being between a location of an own device measured after a predetermined time elapses, and the estimated location of the own device.

### (Supplementary Note 7)

The mobile body according to Supplementary Note 6, wherein

the second means stores a correspondence relationship between each of a plurality of velocities, and a predetermined code, and transmits a code associated with a velocity of an own device to the management device via the first means.

### (Supplementary Note 8)

The mobile body according to Supplementary Note 7, wherein

the second means stores a short code in association with a velocity having a high frequency of appearance within a velocity of an own device.

### (Supplementary Note 9)

The mobile body according to Supplementary Note 7 or 8, wherein

the second means stores a short code in association with an average velocity of the mobile body in a predetermined period.

### (Supplementary Note 10)

The mobile body according to any one of Supplementary Notes 7 to 9, wherein

the second means changes a correspondence relationship between each of a plurality of velocities, and a predetermined code, depending on a characteristic of the mobile body.

### (Supplementary Note 11)

A management device which manages a location of a mobile body, the management device including:

first means for receiving information relating to a velocity of the mobile body from the mobile body; and

second means for estimating a location of the mobile body after a predetermined time elapses, by using a predetermined motion model, based on information relating to a velocity of the mobile body, wherein

the second means manages the estimated location as a location of the mobile body for a period until information relating to a velocity of the mobile body is newly received, after receiving information relating to a velocity of the mobile body.

### (Supplementary Note 12)

A velocity notification method including:

transmitting information relating to a velocity of an own device to a management device;

estimating a location of an own device after a predetermined time elapses, by using a predetermined motion model, based on a velocity of the own device; and

transmitting, to the management device, information relating to a velocity of the own device via first means in response to an error exceeding a predetermined threshold value, the error being between a location of an own device measured after a predetermined time elapses, and the estimated location of the own device.

### (Supplementary Note 13)

The velocity notification method according to Supplementary Note 12, further including:

storing a correspondence relationship between each of a plurality of velocities, and a predetermined code; and

transmitting, to the management device, a code associated with a velocity of an own device via the first means.

### (Supplementary Note 14)

The velocity notification method according to Supplementary Note 13, further including

storing a short code in association with a velocity having a high frequency of appearance within a velocity of an own device.

### (Supplementary Note 15)

The velocity notification method according to Supplementary Note 13 or 14, further including

storing a short code in association with an average velocity of a mobile body in a predetermined period.

### (Supplementary Note 16)

The velocity notification method according to any one of Supplementary Notes 13 to 15, further including

changing a correspondence relationship between each of a plurality of velocities, and a predetermined code, depending on a characteristic of a mobile body.

### (Supplementary Note 17)

A management method including:

receiving information relating to a velocity of a mobile body from the mobile body;

estimating a location of the mobile body after a predetermined time elapses, by using a predetermined motion model, based on information relating to a velocity of the mobile body; and

managing the estimated location as a location of the mobile body for a period until information relating to a velocity of the mobile body is newly received, after receiving information relating to a velocity of the mobile body.

### (Supplementary Note 18)

A storage medium having a program stored thereon, the program causing a computer to execute:

a step of transmitting information relating to a velocity of an own device to a management device;

a step of estimating a location of an own device after a predetermined time elapses, by using a predetermined motion model, based on a velocity of the own device; and

a step of transmitting, to the management device, information relating to a velocity of the own device via first means in response to an error exceeding a predetermined threshold value, the error being between a location of an own device measured after a predetermined time elapses, and the estimated location of the own device.

### (Supplementary Note 19)

A storage medium having a program stored thereon, the program causing a computer to execute:

a step of receiving information relating to a velocity of a mobile body from the mobile body;

a step of estimating a location of the mobile body after a predetermined time elapses, by using a predetermined motion model, based on information relating to a velocity of the mobile body; and

a step of managing the estimated location as a location of the mobile body for a period until information relating to a velocity of the mobile body is newly received, after receiving information relating to a velocity of the mobile body.

### REFERENCE SIGNS LIST

1, 1-1, 1-2, 1A, 1B Mobile body
2 Management device
3 NW
4-1, 4-2, 4-3, 4-4, 4-5 Motion estimation circle
5-1, 5-2, 6-1, 6-2, 6-3 Correspondence relationship
10 Communication unit
11 Control unit
12 Display unit
20 Communication unit
21 Management unit

What is claimed is:

1. A management system comprising:
a mobile body configured to estimate a location of an own device after a predetermined time elapses by using a predetermined motion model, based on a velocity of the own device; and
a management device configured to estimate a location of the mobile body after the predetermined time elapses, by using the predetermined motion model, based on information relating to a velocity of the mobile body, wherein
the mobile body transmits, to the management device, information relating to a velocity of an own device in response to an error exceeding a predetermined threshold value, the error being between a location of an own device measured after a predetermined time elapses, and the estimated location of the own device.

2. The management system according to claim 1, wherein
the mobile body stores a correspondence relationship between each of a plurality of velocities, and a predetermined code, and transmits a code associated with a velocity of an own device to the management device.

3. The management system according to claim 2, wherein
the mobile body stores a short code in association with a velocity having a high frequency of appearance within a velocity of an own device.

4. The management system according to claim 2, wherein
the mobile body stores a short code in association with an average velocity of the mobile body in a predetermined period.

5. The management system according to claim 2, wherein
the mobile body changes a correspondence relationship between each of a plurality of velocities, and a predetermined code, depending on a characteristic of the mobile body.

6. A mobile body comprising:
a first unit configured to transmit information relating to a velocity of an own device to a management device; and
a second unit configured to estimate a location of an own device after a predetermined time elapses, by using a predetermined motion model, based on a velocity of the own device, wherein
the second unit transmits, to the management device, information relating to a velocity of the own device via the first unit in response to an error exceeding a predetermined threshold value, the error being between a location of an own device measured after a predetermined time elapses, and the estimated location of the own device.

7. The mobile body according to claim 6, wherein
the second unit stores a correspondence relationship between each of a plurality of velocities, and a predetermined code, and transmits a code associated with a velocity of an own device to the management device via the first unit.

8. The mobile body according to claim 7, wherein
the second unit stores a short code in association with a velocity having a high frequency of appearance within a velocity of an own device.

9. The mobile body according to claim 7, wherein
the second unit stores a short code in association with an average velocity of the mobile body in a predetermined period.

10. The mobile body according to claim 7, wherein
the second unit changes a correspondence relationship between each of a plurality of velocities, and a predetermined code, depending on a characteristic of the mobile body.

11. A management device which manages a location of a mobile body, the management device comprising:
a first unit configured to receive information relating to a velocity of the mobile body from the mobile body; and
a second unit configured to estimate a location of the mobile body after a predetermined time elapses, by using a predetermined motion model, based on information relating to a velocity of the mobile body, wherein
the second unit manages the estimated location as a location of the mobile body for a period until information relating to a velocity of the mobile body is newly received, after receiving information relating to a velocity of the mobile body.

12. A velocity notification method comprising:
transmitting information relating to a velocity of an own device to a management device;
estimating a location of an own device after a predetermined time elapses, by using a predetermined motion model, based on a velocity of the own device; and
transmitting, to the management device, information relating to a velocity of the own device in response to an error exceeding a predetermined threshold value, the error being between a location of an own device measured after a predetermined time elapses, and the estimated location of the own device.

13. The velocity notification method according to claim 12, further comprising:
storing a correspondence relationship between each of a plurality of velocities, and a predetermined code; and
transmitting, to the management device, a code associated with a velocity of an own device.

14. The velocity notification method according to claim 13, further comprising
storing a short code in association with a velocity having a high frequency of appearance within a velocity of an own device.

15. The velocity notification method according to claim 13, further comprising
storing a short code in association with an average velocity of a mobile body in a predetermined period.

16. The velocity notification method according to claim 13, further comprising
changing a correspondence relationship between each of a plurality of velocities, and a predetermined code, depending on a characteristic of a mobile body.

17. A management method comprising:
receiving information relating to a velocity of a mobile body from the mobile body;
estimating a location of the mobile body after a predetermined time elapses, by using a predetermined motion model, based on information relating to a velocity of the mobile body; and
managing the estimated location as a location of the mobile body for a period until information relating to a velocity of the mobile body is newly received, after receiving information relating to a velocity of the mobile body.

18. A storage medium having a program stored thereon, the program causing a computer to execute:
a step of transmitting information relating to a velocity of an own device to a management device;
a step of estimating a location of an own device after a predetermined time elapses, by using a predetermined motion model, based on a velocity of the own device; and
a step of transmitting, to the management device, information relating to a velocity of the own device in response to an error exceeding a predetermined threshold value, the error being between a location of an own device measured after a predetermined time elapses, and the estimated location of the own device.

19. A storage medium having a program stored thereon, the program causing a computer to execute:
a step of receiving information relating to a velocity of a mobile body from the mobile body;
a step of estimating a location of the mobile body after a predetermined time elapses, by using a predetermined motion model, based on information relating to a velocity of the mobile body; and
a step of managing the estimated location as a location of the mobile body for a period until information relating to a velocity of the mobile body is newly received, after receiving information relating to a velocity of the mobile body.
